(19) United States
(12) Patent Application Publication
(10) Pub. No.: US 2026/0055229 A1
(43) Pub. Date: Feb. 26, 2026

(54) NON-AROMATIC CYCLIC INITIATED POLYCAPROLACTONE, COMPOSITIONS COMPRISING THE SAME, AND METHODS OF MAKING THE SAME

(71) Applicant: INGEVITY UK LTD, Cheshire (GB)

(72) Inventors: JOSEPH SCHOLES, Cheshire (GB); MARK ANDREWS, Cheshire (GB); ANTHONY MAHER, Cheshire (GB)

(21) Appl. No.: 19/305,082

(22) Filed: Aug. 20, 2025

Related U.S. Application Data
(60) Provisional application No. 63/685,942, filed on Aug. 22, 2024.

(51) Int. Cl. C08G 63/08; C08G 18/08; C08G 18/42; C08G 63/82; C08G 101/00

(52) U.S. Cl. CPC C08G 63/08; C08G 18/08; C08G 18/4277; C08G 63/823; C08G 2101/00; C08G 2150/00; C08G 2170/00

(57) ABSTRACT

The present disclosure provides a polycaprolactone composition or polycaprolactone that includes a reaction product of (i) one or more cyclic aliphatic initiator and (ii) one or more unsubstituted or substitute caprolactone monomer, wherein (a) the one or more cyclic aliphatic initiator is present in the range of about 1.0 wt % to about 95.0 wt %, (b) the one or more caprolactone monomer is present in the range of about 5.0 wt % to about 99.0 wt %, and (c) the polycaprolactone has an average molecular weight of about 400 g/mol to about 10,000 g/mol. The disclosure further provides methods of making the polycaprolactone compositions, polycaprolactones, compositions including the same, and methods of making and using the same.

### CROSS-REFERENCE TO RELATED APPLICATIONS

This application claims priority to, and the benefit of, U.S. Provisional Patent Application No. 63/685,942, filed 22 Aug. 2024 and titled NON-AROMATIC CYCLIC INITIATED POLYCAPROLACTONE, COMPOSITIONS COMPRISING THE SAME, AND METHODS OF MAKING THE SAME, which is incorporated by reference herein in its entirety.

### BACKGROUND

### Field of the Discovery

The present disclosure relates to polycaprolactone and polycaprolactone compositions, articles and compositions including the polycaprolactone and polycaprolactone compositions of the present disclosure, and methods for preparing and using the polycaprolactone and polycaprolactone compositions of the present disclosure and articles and compositions comprising the same.

### Background Information

Polycaprolactones are a unique class of polyester polyol that are used, e.g., in the production of polyurethane materials. Polyurethanes based on polycaprolactones are characterized by best-in-class mechanical properties, outstanding durability in harsh environmental conditions, and processing ease, as compared to many alternative materials. For this reason, polycaprolactones find use in very demanding applications where articles are exposed to high temperatures, humid environments, ultraviolet (UV) light, and repeated mechanicals deformations, such as in industrial seals, gaskets, wheels and rollers, paint protection films, and in automotive suspension systems.

However, there still exists is a need for polycaprolactones that provide increased hardness and toughness, whilst still offering the same technical benefits of polycaprolactone, such as exceptional aging performance (e.g., thermal, water, ultraviolet, or a combination thereof), and crystallinity within the polycaprolactone and compositions comprising the same (e.g., polyurethane). The present disclosure addresses this need with novel polycaprolactones and compositions comprising the same.

### SUMMARY

Surprisingly and unexpectedly, it was discovered that the polycaprolactone or polycaprolactone compositions of the present disclosure provide increased hardness and toughness, whilst still offering the same technical benefits of polycaprolactone, such as exceptional aging performance (e.g., thermal, water, ultraviolet, or a combination thereof), and crystallinity within the polycaprolactone and compositions comprising the same (e.g., polyurethane).

An aspect of the present disclosure provides a polycaprolactone composition (e.g., a polycaprolactone polyol composition) comprising, consists essentially of, or consists of, a polycaprolactone (e.g., polycaprolactone polyol) comprising, consists essentially of, or consists of, a reaction product of (i) one or more (e.g., 1, 2, 3, 4, or more) cyclic aliphatic initiator and (ii) one or more (e.g., 1, 2, 3, 4, or more) unsubstituted or substitute caprolactone monomer (e.g., ε-caprolactone), wherein (a) the one or more cyclic aliphatic initiator is present in the range of about 1.0 wt % to about 95.0 wt % of the total molecular weight of the polycaprolactone composition or polycaprolactone, (b) the one or more caprolactone monomer is present in the range of about 5.0 wt % to about 99.0 wt % of the total molecular weight of the polycaprolactone composition or polycaprolactone, and (c) the polycaprolactone (e.g., polycaprolactone polyol) has an average molecular weight of about 400 g/mol to about 10,000 g/mol.

An further aspect of the present disclosure provides a polycaprolactone (e.g., polycaprolactone polyol) comprising, consists essentially of, or consists of, a reaction product of (i) one or more (e.g., 1, 2, 3, 4, or more) cyclic aliphatic initiator and (ii) one or more (e.g., 1, 2, 3, 4, or more) unsubstituted or substitute caprolactone monomer (e.g., ε-caprolactone), wherein (a) the one or more cyclic aliphatic initiator is present in the range of about 1.0 wt % to about 95.0 wt % of the total molecular weight of the polycaprolactone composition or polycaprolactone, (b) the one or more caprolactone monomer is present in the range of about 5.0 wt % to about 99.0 wt % of the total molecular weight of the polycaprolactone composition or polycaprolactone, and (c) the polycaprolactone (e.g., polycaprolactone polyol) has an average molecular weight of about 400 g/mol to about 10,000 g/mol.

Another aspect of the present disclosure provides a method of making or producing the polycaprolactone composition (e.g., polycaprolactone polyol composition) or polycaprolactone (e.g., polycaprolactone polyol) of the present disclosure, the method comprising, consisting essentially of, or consisting of, reacting the one or more cyclic aliphatic initiator and the one or more caprolactone monomer.

An aspect of the present disclosure provides a polycaprolactone composition (e.g., a polycaprolactone polyol composition) comprising, consists essentially of, or consists of, a polycaprolactone (e.g., polycaprolactone polyol) comprising, consists essentially of, or consists of, a reaction product of (i) one or more (e.g., 1, 2, 3, 4, or more) cyclic aliphatic initiator, (ii) one or more (e.g., 1, 2, 3, 4, or more) aliphatic dicarboxylic acid, and (iii) one or more (e.g., 1, 2, 3, 4, or more) unsubstituted or substitute caprolactone monomer (e.g., F-caprolactone), wherein: (a) the one or more cyclic aliphatic initiator and the one or more aliphatic dicarboxylic acid are present in the range of about 1.0 wt % to about 95.0 wt % of the total molecular weight of the polycaprolactone composition, (b) the one or more caprolactone monomer is present in the range of about 5.0 wt % to about 99.0 wt % of the total molecular weight of the polycaprolactone composition, and, and (c) the polycaprolactone (e.g., polycaprolactone polyol) has an average molecular weight of about 400 g/mol to about 10,000 g/mol.

An further aspect of the present disclosure provides a polycaprolactone (e.g., polycaprolactone polyol) comprising, consists essentially of, or consists of, a reaction product of (i) one or more (e.g., 1, 2, 3, 4, or more) cyclic aliphatic initiator, (ii) one or more (e.g., 1, 2, 3, 4, or more) aliphatic dicarboxylic acid, and (iii) one or more (e.g., 1, 2, 3, 4, or more) unsubstituted or substitute caprolactone monomer (e.g., ε-caprolactone), wherein: (a) the one or more cyclic aliphatic initiator and the one or more aliphatic dicarboxylic acid are present in the range of about 1.0 wt % to about 95.0 wt % of the total molecular weight of the polycaprolactone composition, (b) the one or more caprolactone monomer is present in the range of about 5.0 wt % to about 99.0 wt % of the total molecular weight of the polycaprolactone composition, and, and (c) the polycaprolactone (e.g., polycaprolactone polyol) has an average molecular weight of about 400 g/mol to about 10,000 g/mol.

Another aspect of the present disclosure provides a method of making or producing the polycaprolactone composition (e.g., polycaprolactone polyol composition) or polycaprolactone (e.g., polycaprolactone polyol) of the present disclosure, the method comprising, consisting essentially of, or consisting of, reacting the one or more cyclic aliphatic initiator, the one or more aliphatic dicarboxylic acid, and the one or more caprolactone monomer.

A further aspect of the present disclosure provides a polymeric composition comprising, consisting essentially of, or consists of a reaction product of: (a) one or more (e.g., 1, 2, 3, 4, or more) polycaprolactone composition (e.g., polycaprolactone polyol composition) or polycaprolactone (e.g., polycaprolactone polyol) of the present disclosure, or produced according to the method of the present disclosure, that is present in the range of about 5.0 wt % to about 95.0 wt % of the polymeric composition, wherein the one or more polycaprolactone composition or polycaprolactone has an average molecular weight of about 400 g/mol to about 10,000 g/mol; (b) one or more (e.g., 1, 2, 3, 4, or more) diisocyanate that is present in the range of about 5.0 wt % to about 95.0 wt % of the polymeric composition; (c) optionally one or more (e.g., 1, 2, 3, 4, or more) additional polyol that is present in the range of about 0.0 wt % to about 90.0 wt % of the polymeric composition; and (d) optionally one or more (e.g., 1, 2, 3, 4, or more) chain extender, wherein the one or more chain extender comprises, consists essentially of, or consists of, at least one of, one or more (e.g., 1, 2, 3, 4, or more) diol chain extender, one or more (e.g., 1, 2, 3, 4, or more) diamine chain extender, or a combination thereof, wherein the one or more chain extender has a molecular weight of about 60.0 g/mol to about 600.0 g/mol, with an NCO:OH molar ratio of about 0.9:1 to about 2:1, and is present in a range of about 0.0 wt % to about 25.0 wt % of the polymeric composition.

An additional aspect of the present disclosure provides a method of making or producing the polymeric composition of the present disclosure, the method comprising, consisting essentially of, or consists of, reacting the one or more polycaprolactone composition (e.g., polycaprolactone polyol composition) or polycaprolactone (e.g., polycaprolactone polyol), the one or more diisocyanate, optionally one or more additional polyol, and optionally, the one or more chain extender.

Another aspect of the present disclosure provides a thermoplastic polyurethane, a thermoplastic polyurethane elastomer, a hot cast elastomer, a cold cast elastomer, a slabstock polyurethane foam, a moulded polyurethane foam, a microcellular polyurethane foam, a polyurethane dispersion in aqueous or organic media, a polyurethane adhesive, a one-component polyurethane coating, a two-component polyurethane coating, a additive manufacturing composition/resin, or a polyurethane sealant, comprising, consisting essentially of, or consisting of, the one or more polycaprolactone composition (e.g., polycaprolactone polyol composition) or polycaprolactone (e.g., polycaprolactone polyol) of the present disclosure, the polycaprolactone composition (e.g., polycaprolactone polyol composition) or polycaprolactone (e.g., polycaprolactone polyol) prepared according to the method of the present disclosure, the polymeric composition of the present disclosure, or a polymeric composition prepared according to the method of the present disclosure.

### BRIEF DESCRIPTION OF THE DRAWINGS

The accompanying drawings, which are incorporated into and form a part of the specification, illustrate several embodiments of the present disclosure and, together with the description, serve to explain the principles of the disclosure. The drawings are only for the purpose of illustrating embodiments of the disclosure and are not to be construed as limiting the disclosure. Further objects, features and advantages of the disclosure will become apparent from the following detailed description taken in conjunction with the accompanying figures showing illustrative embodiments of the disclosure.

FIG. 1 shows the Shore A values of thermoplastic polyurethane elastomer (TPE) prepared with exemplary polycaprolactones compositions of the present disclosure and commercially available comparative polyols.

FIG. 2 shows the Shore D values of thermoplastic polyurethane elastomer (TPE) prepared with exemplary polycaprolactones compositions of the present disclosure and commercially available comparative polyols.

### DETAILED DESCRIPTION OF THE INVENTION

Presently described are polycaprolactone compositions and polycaprolactones that provide increased hardness and toughness, whilst still offering the same technical benefits of polycaprolactone, such as exceptional aging performance (e.g., thermal, water, ultraviolet, or a combination thereof), and crystallinity within the polycaprolactone and compositions comprising the same (e.g., polyurethane).

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value in the range, to the tenth of the unit of the lower limit unless the context clearly dictates otherwise (e.g., in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either/or both of those included limits are also included in the disclosure.

It should also be understood that, in certain methods or processes described herein that include more than one step or act, the order of the steps or acts of the method is not necessarily limited to the order in which the steps or acts of the method are recited unless the context indicates otherwise.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (that is, to at least one or one or more of) of the grammatical object of the article unless the context clearly indicates otherwise. By way of example, “an element” means one element or more than one element, unless otherwise indicated.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, that is, “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (that is, “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended (that is, to mean including but not limited to). It is expressly contemplated that all embodiments, and claims reciting one of the open-ended transitional phrases can be written with any other transitional phrase, which may be more limiting (e.g., “consisting essentially of” or “consisting of”), unless clearly precluded by the context or art. Only the transitional phrases “consisting of” and “consisting essentially of” shall be closed or semi-closed transitional phrases, respectively, as set forth in the United States Patent Office Manual of Patent Examining Procedures, Section 2111.03.

The term “independently” is used herein to indicate that the variable, which is independently applied, varies independently from application to application.

The term “optional” or “optionally”, as used herein, means that the subsequently described event or circumstance may or may not occur, and that the description includes instances where said event or circumstance occurs and instances where it does not.

The term The term “substituted” or “optionally substituted”, as used herein, means that any one or more (e.g., 1, 2, 3, 4, 5, 6, 7, 8, 9, or more) hydrogens on the designated atom or group is replaced (e.g., replaced with a selection from an indicated group) provided that the designated atom's normal valence is not exceeded. For example, when the substituent is oxo (that is, ═O) then two hydrogens on the atom are replaced. When an oxo group substitutes a heteroaromatic moiety, the resulting molecule can sometimes adopt tautomeric forms. For example, a pyridyl group substituted by oxo at the 2-position or 4-position can sometimes be written as a pyridine or hydroxypyridine. Combinations of substituents and/or variables are permissible only if such combinations result in stable compounds or useful synthetic intermediates. A stable compound or stable structure is meant to imply a compound that is sufficiently robust to survive isolation from a reaction mixture and subsequent formulation. In any aspect or embodiment described herein, substituted (e.g., an optionally substituted) is one or more independently selected substituents (e.g., 0 substituents, 1 substituent, 2 substituents, 3 substituents, 4 substituents, 5 substituents, or a combination thereof) on any atom (e.g., a carbon or nitrogen atom) of the element or moiety that is substituted and may include substituents, which themselves may be optionally substituted, as described herein, at an atom located on the element, moiety, or compound that is substituted. For example, in any aspect or embodiment described herein, each substitution or substituent is independently selected from hydroxyl (—OH), C₁₋₁₀ thiol (e.g., C₁₋₆ thiol or C₁₋₃ thiol), carboxyl (—COOH), cyano (—CN), nitro (—NO₂), imino (═NH), halogen (e.g., F, Cl, Br, I, and/or 1, 2 or 3 halogens, especially on an alkyl group, including a methyl group (e.g., trifluoromethyl)), a C₁₋₁₀ alkyl (e.g., C₁₋₆ alkyl or C₁₋₃ alkyl), a C₁₋₁₀ alkenyl (e.g., C₁₋₆ alkenyl or C₁₋₃ alkenyl), a C₁₋₁₀ alkynyl (e.g., C₁₋₆ alkynyl or C₁₋₃ alkynyl), aryl (e.g., a 6-, 7-, 8-, 9-, or 10-membered aryl), heteroaryl (e.g., a 5-, 6-, 7-, 8-, 9-, or 10-membered aryl), cycloalkyl (e.g., a 3-, 4-, 5-, 6-, 7-, 8-, 9-, or 10-membered cycloalkyl), heterocycloalkyl (e.g., a 3-, 4-, 5-, 6-, 7-, 8-, 9-, or 10-membered heterocycloalkyl), C₁₋₁₀ alkoxy (e.g., C₁₋₆ alkoxy or C₁₋₃ alkoxy), C₁₋₁₀ thioether (e.g., C₁₋₆ thioether or C₁₋₃ thioether), C₁₋₁₀ acyl (e.g., C₁₋₆ acyl or C₁₋₃ acyl), C₁₋₁₀ ester (e.g., C₁₋₆ ester, C₁₋₃ ester, and/or for example, C₁₋₆, or C₁₋₃ ester alkylene ester), C₁₋₁₀ thioester (e.g., C₁₋₆ thioester, C₁₋₃ thioester, optionally substituted amino (e.g., —NH₂, C₁₋₆ alkyl amine, C₁₋₆ dialkyl amine, —C₁₋₆ alkylene-NR1R2, or —(CH₂)ₘ—NR1R2, wherein m is 0, 1, 2, 3, 4, 5, 6, 7, 8, 9, or 10, and R1 and R2 are independently H or C₁₋₆ alkyl group, optionally substituted with one or more groups (e.g., 1, 2, 3, 4, or 5 groups) independently selected from hydroxyl and halogen (e.g., F, Br, Cl, or I)), —(CH₂)ₘCOOH (wherein m is 0, 1, 2, 3, 4, 5, 6, 7, 8, 9, or 10), —(CH₂)ₘOH (wherein m is 0, 1, 2, 3, 4, 5, 6, 7, 8, 9, or 10), hydrazine, optionally substituted amido (—CO—NH₂) (e.g., optionally substituted with one or two independently selected C₁₋₆ C₁-3 alkyl groups, C₁₋₁₀ alkanol (e.g., C₁₋₆ alkanol or C₁₋₃ alkanol), C₁₋₁₀ alkanoic acid (e.g., C₁₋₆ alkanoic acid or C₁₋₃ alkanoic acid). “unsubstituted” shall mean substituted only with hydrogen atoms.

As used herein, the term “caprolactone” is intended to encompass unsubstituted caprolactone and substituted caprolactone. The term “ε-caprolactone” is intended to encompass unsubstituted ε-caprolactone and substituted ε-caprolactone. Unsubstituted ε-caprolactone is particularly preferred.

In any aspect or embodiment described herein, substituted ε-caprolactone monomers that may be used in the production of the caprolactone polyols include, consists essentially of, or consists of, at least one of C₁₋₁₂ alkyl substituted ε-caprolactone, alkenyl substituted ε-caprolactone (e.g., C₂₋₁₂ alkenyl substituted ε-caprolactone), alkynyl substituted ε-caprolactone (e.g., C₂₋₁₂ alkynyl substituted ε-caprolactone), cycloalkyl substituted F-caprolactone (e.g., C₁₋₁₈ cycloalkyl substituted ε-caprolactone), alkoxy substituted F-caprolactone (e.g., C₁₋₁₂ alkoxy substituted ε-caprolactone), aryl substituted ε-caprolactone (e.g., C₁₋₁₈ aryl substituted ε-caprolactone), alkaryl substituted ε-caprolactone (e.g., C₁₋₁₈ alkaryl substituted ε-caprolactone), aralkyl substituted ε-caprolactone (e.g., C₁₋₁₈ aralkyl substituted ε-caprolactone), aryloxy substituted ε-caprolactone (e.g., C₁₋₁₈ aryloxy substituted ε-caprolactone), or mixtures thereof.

In any aspect or embodiment described herein, substituted ε-caprolactone monomers that may be used in the production of the polycaprolactones include mono-, di- or tri-substituted monomers. In any aspect or embodiment described herein, exemplary substituted ε-caprolactone monomers include, consists essentially of, or consists of, at least one of monomethyl ε-caprolactone, monoethyl ε-caprolactone, monopropyl ε-caprolactone, monomethoxy ε-caprolactone, monoethoxy ε-caprolactone, monopropoxy ε-caprolactone, monobenzyl ε-caprolactone, monophenyl ε-caprolactone, dimethyl ε-caprolactone, diethyl F-caprolactone, dipropyl ε-caprolactone, dimethoxy ε-caprolactone, diethoxy ε-caprolactone, dipropoxy ε-caprolactone, dibenzyl ε-caprolactone, diphenyl ε-caprolactone, or mixtures thereof.

The term “alkyl” shall mean within its context a linear, branch-chained or cyclic fully saturated hydrocarbon radical, such as a C₁-C₁₅, a C₁-C₁₂, a C₁-C₁₀, a C₁-C₆, a C₁-C₅, or a C₁-C₃ alkyl group, which is optionally substituted with any suitable functional group or groups (e.g., optionally substituted as described herein). Examples of alkyl groups are methyl, ethyl, butyl, n-butyl, sec-butyl, pentyl, hexyl, n-hexyl, n-heptyl, n-octyl, n-nonyl, n-decyl, isopropyl, 2-methylpropyl, cyclopropyl, cyclopropylmethyl, cyclobutyl, cyclopentyl, cyclopentylethyl, cyclohexyl, cyclohexylethyl and cyclohexyl, among others.

The term “alkenyl” refers to a linear, branch-chained, or cyclic C₂-C₁₂ (e.g., C₂-C₁₀ or C₂-C₆) hydrocarbon radicals containing at least one C═C bond, which is optionally substituted with any suitable functional group or groups (e.g., optionally substituted as described herein).

The term “alkynyl” refers to linear, branch-chained, or cyclic C₂-C₁₂ (e.g., C₂-C₁₀ or C₂-C₆) hydrocarbon radicals containing at least one C≡C bond, which is optionally substituted with any suitable functional group or groups (e.g., optionally substituted as described herein).

The term “cycloalkyl” refers to a univalent saturated, monocyclic hydrocarbon ring or saturated, polycyclic hydrocarbon fused ring system, wherein each ring is independently a 3-, 4-, 5-, 6-, 7-, 8-, 9-, 10-, 11-, 12-, 13-, 14-, 15-, 16-, 17-, 18-, 19-, or 20-member ring (e.g., each ring is independently cyclopropyl, cyclobutyl, cyclopentyl, cyclohexyl, or cycloheptyl), and is optionally substituted with any suitable functional group or groups (e.g., optionally substituted as described herein).

The term “alkoxy” shall mean an alkyl group, as defined herein, with the indicated number of carbon atoms covalently bound to the group it substitutes by an oxygen bridge (—O—), which is optionally substituted with any suitable functional group or groups (e.g., optionally substituted as described herein). Examples, in any aspect or embodiment described herein, the alkoxy groups include, but are not limited to, methoxy, ethoxy, n-propoxy, i-propoxy, n-butoxy, 2-butoxy, t-butoxy, n-pentoxy, 2-pentoxy, 3-pentoxy, isopentoxy, neopentoxy, n-hexoxy, 2-hexoxy, 3-hexoxy, or 3-methylpentoxy.

The term “aryl” refers to a substituted (i.e., substituted with any suitable functional group or groups (e.g., optionally substituted as described herein)) or unsubstituted monovalent aromatic radical (e.g., a 5-, 6-, 7-, 8-, 9-, 10-, 11-, 12-, 13-, 14-, 15-, or 16-membered ring) having a single ring (e.g., benzene, phenyl, benzyl, or 5-, 6-, 7-, 8-, 9-, or 10-membered ring) or condensed rings (e.g., naphthyl, anthracenyl, phenanthrenyl, 10-, 11-, 12-, 13-, 14-, 15-, or 16-membered ring, etc.) and can be bound to the parent moiety at any available stable position on the ring(s) or as otherwise indicated in the chemical structure presented.

The term “alkaryl” refers to a group that comprises an aryl and one or more alkyl attached to the aryl, which is optionally substituted with any suitable functional group or groups (e.g., optionally substituted as described herein), wherein the aralkyl is attached to the parent moiety through an alkyl group.

The term “aralkyl” refers to a group that comprises an aryl and one or more alkyl attached to the aryl, which is optionally substituted with any suitable functional group or groups (e.g., optionally substituted as described herein), wherein the aralkyl is attached to the parent moiety through the aryl.

The term “aryloxy” refers to a group that comprises an aryl and one or more alkoxy attached to the aryl, which is optionally substituted with any suitable functional group or groups (e.g., optionally substituted as described herein), wherein the aryloxy is attached to the parent moiety through the aryl.

### Polycaprolactones, Polycaprolactone Compositions, and Methods of Making the Same

An aspect of the present disclosure provides a polycaprolactone (e.g., polycaprolactone polyol) comprising, consists essentially of, or consists of, a reaction product of (i) one or more (e.g., 1, 2, 3, 4, or more) cyclic aliphatic initiator and (ii) one or more (e.g., 1, 2, 3, 4, or more) unsubstituted or substitute caprolactone monomer (e.g., ε-caprolactone), wherein (a) the one or more cyclic aliphatic initiator is present in the range of about 1.0 wt % to about 95.0 wt % of the total molecular weight of the polycaprolactone composition or polycaprolactone, (b) the one or more caprolactone monomer is present in the range of about 5.0 wt % to about 99.0 wt % of the total molecular weight of the polycaprolactone composition or polycaprolactone, and (c) the polycaprolactone (e.g., polycaprolactone polyol) has an average molecular weight of about 400 g/mol to about 10,000 g/mol.

A further aspect of the present disclosure provides a polycaprolactone composition (e.g., a polycaprolactone polyol composition) comprising, consists essentially of, or consists of, a polycaprolactone (e.g., polycaprolactone polyol) comprising, consists essentially of, or consists of, a reaction product of (i) one or more (e.g., 1, 2, 3, 4, or more) cyclic aliphatic initiator and (ii) one or more (e.g., 1, 2, 3, 4, or more) unsubstituted or substitute caprolactone monomer (e.g., ε-caprolactone), wherein (a) the one or more cyclic aliphatic initiator is present in the range of about 1.0 wt % to about 95.0 wt % of the total molecular weight of the polycaprolactone composition or polycaprolactone, (b) the one or more caprolactone monomer is present in the range of about 5.0 wt % to about 99.0 wt % of the total molecular weight of the polycaprolactone composition or polycaprolactone, and (c) the polycaprolactone (e.g., polycaprolactone polyol) has an average molecular weight of about 400 g/mol to about 10,000 g/mol.

An additional aspect of the present disclosure provides a polycaprolactone composition (e.g., a polycaprolactone polyol composition) comprising, consists essentially of, or consists of, a reaction product of (i) one or more (e.g., 1, 2, 3, 4, or more) cyclic aliphatic initiator and (ii) one or more (e.g., 1, 2, 3, 4, or more) unsubstituted or substitute caprolactone monomer (e.g., ε-caprolactone), wherein (a) the one or more cyclic aliphatic initiator is present in the range of about 1.0 wt % to about 95.0 wt % of the total molecular weight of the polycaprolactone, (b) the one or more caprolactone monomer is present in the range of about 5.0 wt % to about 99.0 wt % of the total molecular weight of the polycaprolactone, and (c) the polycaprolactone (e.g., polycaprolactone polyol) has an average molecular weight of about 400 g/mol to about 10,000 g/mol.

Another aspect of the present disclosure provides a method of making or producing the polycaprolactone composition (e.g., polycaprolactone polyol composition) or polycaprolactone (e.g., polycaprolactone polyol) of the present disclosure, the method comprising, consisting essentially of, or consisting of, reacting the one or more cyclic aliphatic initiator and the one or more caprolactone monomer.

An aspect of the present disclosure provides a polycaprolactone composition (e.g., a polycaprolactone polyol composition) comprising, consists essentially of, or consists of, a polycaprolactone (e.g., polycaprolactone polyol) comprising, consists essentially of, or consists of, a reaction product of (i) one or more (e.g., 1, 2, 3, 4, or more) cyclic aliphatic initiator, (ii) one or more (e.g., 1, 2, 3, 4, or more) aliphatic dicarboxylic acid, and (iii) one or more (e.g., 1, 2, 3, 4, or more) unsubstituted or substitute caprolactone monomer (e.g., F-caprolactone), wherein: (a) the one or more cyclic aliphatic initiator and the one or more aliphatic dicarboxylic acid are present in the range of about 1.0 wt % to about 95.0 wt % of the total molecular weight of the polycaprolactone composition, (b) the one or more caprolactone monomer is present in the range of about 5.0 wt % to about 99.0 wt % of the total molecular weight of the polycaprolactone composition, and, and (c) the polycaprolactone (e.g., polycaprolactone polyol) has an average molecular weight of about 400 g/mol to about 10,000 g/mol.

An further aspect of the present disclosure provides a polycaprolactone (e.g., polycaprolactone polyol) comprising, consists essentially of, or consists of, a reaction product of (i) one or more (e.g., 1, 2, 3, 4, or more) cyclic aliphatic initiator, (ii) one or more (e.g., 1, 2, 3, 4, or more) aliphatic dicarboxylic acid, and (iii) one or more (e.g., 1, 2, 3, 4, or more) unsubstituted or substitute caprolactone monomer (e.g., ε-caprolactone), wherein: (a) the one or more cyclic aliphatic initiator and the one or more aliphatic dicarboxylic acid are present in the range of about 1.0 wt % to about 95.0 wt % of the total molecular weight of the polycaprolactone composition, (b) the one or more caprolactone monomer is present in the range of about 5.0 wt % to about 99.0 wt % of the total molecular weight of the polycaprolactone composition, and, and (c) the polycaprolactone (e.g., polycaprolactone polyol) has an average molecular weight of about 400 g/mol to about 10,000 g/mol.

Another aspect of the present disclosure provides a method of making or producing the polycaprolactone composition (e.g., polycaprolactone polyol composition) or polycaprolactone (e.g., polycaprolactone polyol) of the present disclosure, the method comprising, consisting essentially of, or consisting of, reacting the one or more cyclic aliphatic initiator, the one or more aliphatic dicarboxylic acid, and the one or more caprolactone monomer.

In any aspect or embodiment described herein, the one or more cyclic aliphatic initiator is present in the range of about 1.0 wt % to about 95.0 wt %, about 1.0 wt % to about 90.0 wt %, about 1.0 wt % to about 85.0 wt %, about 1.0 wt % to about 80.0 wt %, about 1.0 wt % to about 75.0 wt %, about 1.0 wt % to about 70.0 wt %, about 1.0 wt % to about 65.0 wt %, about 1.0 wt % to about 60.0 wt %, about 1.0 wt % to about 55.0 wt %, about 1.0 wt % to about 50.0 wt %, about 1.0 wt % to about 45.0 wt %, about 1.0 wt % to about 40.0 wt %, about 1.0 wt % to about 35.0 wt %, about 1.0 wt % to about 30.0 wt %, about 1.0 wt % to about 25.0 wt %, about 1.0 wt % to about 20.0 wt %, about 1.0 wt % to about 15.0 wt %, about 1.0 wt % to about 10.0 wt %, about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, about 85.0 wt % to about 95.0 wt % of the total molecular weight of the polycaprolactone composition or polycaprolactone.

In any aspect or embodiment described herein, the one or more cyclic aliphatic initiator and the one or more aliphatic dicarboxylic acid are present in the range of about 1.0 wt % to about 95.0 wt %, about 1.0 wt % to about 90.0 wt %, about 1.0 wt % to about 85.0 wt %, about 1.0 wt % to about 80.0 wt %, about 1.0 wt % to about 75.0 wt %, about 1.0 wt % to about 70.0 wt %, about 1.0 wt % to about 65.0 wt %, about 1.0 wt % to about 60.0 wt %, about 1.0 wt % to about 55.0 wt %, about 1.0 wt % to about 50.0 wt %, about 1.0 wt % to about 45.0 wt %, about 1.0 wt % to about 40.0 wt %, about 1.0 wt % to about 35.0 wt %, about 1.0 wt % to about 30.0 wt %, about 1.0 wt % to about 25.0 wt %, about 1.0 wt % to about 20.0 wt %, about 1.0 wt % to about 15.0 wt %, about 1.0 wt % to about 10.0 wt %, about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, about 85.0 wt % to about 95.0 wt % of the total molecular weight of the polycaprolactone composition or polycaprolactone.

In any aspect or embodiment described herein, the one or more caprolactone monomer is present in the range of about 5.0 wt % to about 99.0 wt %, about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 5.0 wt % to about 99.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 99.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 99.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 99.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 99.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 99.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 99.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 99.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 99.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 99.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 99.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 99.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 99.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 99.0 wt %, about 75.0 wt % to about 95.0 wt %, about 75.0 wt % to about 90.0 wt %, about 75.0 wt % to about 85.0 wt %, about 85.0 wt % to about 99.0 wt %, about 80.0 wt % to about 95.0 wt %, about 80.0 wt % to about 90.0 wt %, about 85.0 wt % to about 99.0 wt %, about 85.0 wt % to about 95.0 wt %, or about 90.0 wt % to about 99.0 wt %, of the total molecular weight of the polycaprolactone composition or polycaprolactone.

In any aspect or embodiment described herein, the polycaprolactone (e.g., polycaprolactone polyol) has an average molecular weight of about 400 g/mol to about 10,000 g/mol, about 400 g/mol to about 9,000 g/mol, about 400 g/mol to about 8,000 g/mol, about 400 g/mol to about 7,000 g/mol, about 400 g/mol to about 6,000 g/mol, about 400 g/mol to about 5,000 g/mol, about 400 g/mol to about 4,000 g/mol, about 400 g/mol to about 3,000 g/mol, about 400 g/mol to about 2,000 g/mol, about 1,000 g/mol to about 10,000 g/mol, about 1,000 g/mol to about 9,000 g/mol, about 1,000 g/mol to about 8,000 g/mol, about 1,000 g/mol to about 7,000 g/mol, about 1,000 g/mol to about 6,000 g/mol, about 1,000 g/mol to about 5,000 g/mol, about 1,000 g/mol to about 4,000 g/mol, about 1,000 g/mol to about 3,000 g/mol, about 1,000 g/mol to about 2,000 g/mol, about 1,500 g/mol to about 10,000 g/mol, about 1,500 g/mol to about 9,000 g/mol, about 1,500 g/mol to about 8,000 g/mol, about 1,500 g/mol to about 7,000 g/mol, about 1,500 g/mol to about 6,000 g/mol, about 1,500 g/mol to about 5,000 g/mol, about 1,500 g/mol to about 4,000 g/mol, about 1,500 g/mol to about 3,000 g/mol, about 2,000 g/mol to about 10,000 g/mol, about 2,000 g/mol to about 9,000 g/mol, about 2,000 g/mol to about 8,000 g/mol, about 2,000 g/mol to about 7,000 g/mol, about 2,000 g/mol to about 6,000 g/mol, about 2,000 g/mol to about 5,000 g/mol, about 2,000 g/mol to about 4,000 g/mol, about 2,000 g/mol to about 3,000 g/mol, about 2,500 g/mol to about 10,000 g/mol, about 2,500 g/mol to about 9,000 g/mol, about 2,500 g/mol to about 8,000 g/mol, about 2,500 g/mol to about 7,000 g/mol, about 2,500 g/mol to about 6,000 g/mol, about 2,500 g/mol to about 5,000 g/mol, about 2,500 g/mol to about 4,000 g/mol, about 3,000 g/mol to about 10,000 g/mol, about 3,000 g/mol to about 9,000 g/mol, about 3,000 g/mol to about 8,000 g/mol, about 3,000 g/mol to about 7,000 g/mol, about 3,000 g/mol to about 6,000 g/mol, about 3,000 g/mol to about 5,000 g/mol, about 3,000 g/mol to about 4,000 g/mol, about 3,500 g/mol to about 10,000 g/mol, about 3,500 g/mol to about 9,000 g/mol, about 3,500 g/mol to about 8,000 g/mol, about 3,500 g/mol to about 7,000 g/mol, about 3,500 g/mol to about 6,000 g/mol, about 3,500 g/mol to about 5,000 g/mol, about 4,000 g/mol to about 10,000 g/mol, about 4,000 g/mol to about 9,000 g/mol, about 4,000 g/mol to about 8,000 g/mol, about 4,000 g/mol to about 7,000 g/mol, about 4,000 g/mol to about 6,000 g/mol, about 4,000 g/mol to about 5,000 g/mol, about 4,500 g/mol to about 10,000 g/mol, about 4,500 g/mol to about 9,000 g/mol, about 4,500 g/mol to about 8,000 g/mol, about 4,500 g/mol to about 7,000 g/mol, about 4,500 g/mol to about 6,000 g/mol, about 5,000 g/mol to about 10,000 g/mol, about 5,000 g/mol to about 9,000 g/mol, about 5,000 g/mol to about 8,000 g/mol, about 5,000 g/mol to about 7,000 g/mol, about 5,000 g/mol to about 6,000 g/mol, about 5,500 g/mol to about 10,000 g/mol, about 5,500 g/mol to about 9,000 g/mol, about 5,500 g/mol to about 8,000 g/mol, about 5,500 g/mol to about 7,000 g/mol, about 6,000 g/mol to about 10,000 g/mol, about 6,000 g/mol to about 9,000 g/mol, about 6,000 g/mol to about 8,000 g/mol, about 6,000 g/mol to about 7,000 g/mol, about 6,500 g/mol to about 10,000 g/mol, about 6,500 g/mol to about 9,000 g/mol, about 6,500 g/mol to about 8,000 g/mol, about 7,000 g/mol to about 10,000 g/mol, about 7,000 g/mol to about 9,000 g/mol, about 7,000 g/mol to about 8,000 g/mol, about 7,500 g/mol to about 10,000 g/mol, about 7,500 g/mol to about 9,000 g/mol, about 8,000 g/mol to about 10,000 g/mol, about 8,000 g/mol to about 9,000 g/mol, or about 8,500 g/mol to about 10,000 g/mol.

In any aspect or embodiment described herein, the reaction product is produced by a process comprising, consisting essentially of, or consisting of, at least one of: (a) reacting the one or more cyclic aliphatic initiator and the one or more caprolactone monomer; (b) reacting the one or more cyclic aliphatic initiator and the one or more caprolactone monomer at a temperature of about 120° C. to about 200° C.; (c) reacting the one or more cyclic aliphatic initiator and the one or more caprolactone monomer for about 0.25 hours to about 100.0 hours; (d) reacting the one or more cyclic aliphatic initiator and the one or more caprolactone monomer in a standard atmosphere or an inert atmosphere (e.g., a nitrogen atmosphere, an argon atmosphere, or a combination thereof); (e) reacting the one or more cyclic aliphatic initiator and the one or more caprolactone monomer at a pressure of less than about 1,000 millibar (mbar); (f) reacting the one or more cyclic aliphatic initiator and the one or more caprolactone monomer in the presence of a catalyst (e.g., a catalyst for ring-opening polymerization); or (g) a combination thereof.

In any aspect or embodiment described herein, at least one of: (i) the one or more aliphatic dicarboxylic acid comprises, consists essentially of, or consists of, at least one of one or more (e.g., 1, 2, 3, 4, or more) cyclic aliphatic dicarboxylic acid (e.g., cyclohexanediacid, such as 1,1-cyclohexanediacid, 1,2-cyclohexanediacid, 1,3-cyclohexanediacid, or 1,4-cyclohexanediacid, or a combination thereof), one or more (e.g., 1, 2, 3, 4, or more) linear aliphatic dicarboxylic acid (e.g., a C₃₋₁₀ linear aliphatic dicarboxylic acid, a C₄₋₈ linear aliphatic dicarboxylic acid, a C₄₋₆ linear aliphatic dicarboxylic acid, glutaric acid, or a combination thereof), or a combination thereof. For example, in any aspect or embodiment described herein, the one or more aliphatic dicarboxylic acid comprises, consists essentially of, or consists of, cyclohexanediacid (e.g., 1,1-cyclohexanediacid, 1,2-cyclohexanediacid, 1,3-cyclohexanediacid, or 1,4-cyclohexanediacid, or a combination thereof), or a combination thereof; (ii) a ratio of the one or more cyclic aliphatic initiator to the one or more aliphatic dicarboxylic acid is about 3:1 to about 2:3 (e.g., about 3:2); or (iii) a combination thereof. By way of further example, in any aspect or embodiment described herein, the one or more aliphatic dicarboxylic acid comprises, consists essentially of, or consists of, a C₃₋₁₀ linear aliphatic dicarboxylic acid (e.g., a C₄₋₈ linear aliphatic dicarboxylic acid, a C₄₋₆ linear aliphatic dicarboxylic acid, glutaric acid, or a combination thereof). In any aspect or embodiment described herein, a ratio of the one or more cyclic aliphatic initiator to the one or more aliphatic dicarboxylic acid is about 3:1 to about 2:3 (e.g., about 3:2). For example, in any aspect or embodiment described herein, a ratio of the one or more cyclic aliphatic initiator to the one or more aliphatic dicarboxylic acid is about 3:1 to about 2:3, about 2:1 to about 2:3, about 3:2 to about 2:3, about 6:5 to about 2:3, about 1:1 to about 2:3, about 3:1 to about 5:6, about 2:1 to about 5:6, about 3:2 to about 5:6, about 6:5 to about 5:6, about 3:1 to about 1:1, about 2:1 to about 1:1, about 3:2 to about 1:1, about 6:5 to about 1:1, about 3:1 to about 6:5, about 2:1 to about 6:5, about 3:2 to about 6:5, about 3:1 to about 3:2, or about 3:2.

In any aspect or embodiment described herein, the reaction product is produced by a process comprising, consisting essentially of, or consisting of, at least one of: (a) reacting the one or more cyclic aliphatic initiator, the one or more aliphatic dicarboxylic acid, and the one or more caprolactone monomer; (b) reacting the one or more cyclic aliphatic initiator, the one or more aliphatic dicarboxylic acid, and the one or more caprolactone monomer at a temperature of about 120° C. to about 200° C. (e.g., about 160° C. to about 200° C.); (c) reacting the one or more cyclic aliphatic initiator, the one or more aliphatic dicarboxylic acid, and the one or more caprolactone monomer for about 0.25 hours to about 100.0 hours; (d) reacting the one or more cyclic aliphatic initiator, the one or more aliphatic dicarboxylic acid, and the one or more caprolactone monomer in a standard atmosphere or an inert atmosphere (e.g., a nitrogen atmosphere, an argon atmosphere, or a combination thereof); (e) reacting the one or more cyclic aliphatic initiator, the one or more aliphatic dicarboxylic acid, and the one or more caprolactone monomer at a pressure of less than about 1,000 millibar (mbar); (f) reacting the one or more cyclic aliphatic initiator, the one or more aliphatic dicarboxylic acid, and the one or more caprolactone monomer in the presence of a catalyst (e.g., a catalyst for ring-opening polymerization); or (g) a combination thereof.

In any aspect or embodiment described herein, reacting the one or more cyclic aliphatic initiator and the one or more caprolactone monomer comprises, consists essentially of, or consists of, polymerizing (e.g., ring opening polymerization) the one or more cyclic aliphatic initiator and the one or more caprolactone monomer.

In any aspect or embodiment described herein, reacting the one or more cyclic aliphatic initiator and the one or more caprolactone monomer comprises, consists essentially of, or consists of, polymerizing (e.g., ring opening polymerization) the one or more cyclic aliphatic initiator, the one or more aliphatic dicarboxylic acid, and the one or more caprolactone monomer.

For example, in any aspect or embodiment described herein, reacting the one or more cyclic aliphatic initiator, optionally the one or more aliphatic dicarboxylic acid, and the one or more caprolactone monomer is performed at a temperature of about 120° C. to about 200° C., about 120° C. to about 190° C., about 120° C. to about 180° C., about 120° C. to about 170° C., about 120° C. to about 160° C., about 120° C. to about 150° C., about 120° C. to about 140° C., about 120° C. to about 130° C., about 130° C. to about 200° C., about 130° C. to about 190° C., about 130° C. to about 180° C., about 130° C. to about 170° C., about 130° C. to about 160° C., about 130° C. to about 150° C., about 130° C. to about 140° C., about 140° C. to about 200° C., about 140° C. to about 190° C., about 140° C. to about 180° C., about 140° C. to about 170° C., about 140° C. to about 160° C., about 140° C. to about 150° C., about 150° C. to about 200° C., about 150° C. to about 190° C., about 150° C. to about 180° C., about 150° C. to about 170° C., about 150° C. to about 160° C., about 160° C. to about 200° C., about 160° C. to about 190° C., about 160° C. to about 180° C., about 160° C. to about 170° C., about 170° C. to about 200° C., about 170° C. to about 190° C., about 170° C. to about 180° C., about 180° C. to about 200° C., about 180° C. to about 190° C., or about 190° C. to about 200° C.

For example, in any aspect or embodiment described herein, reacting the one or more cyclic aliphatic initiator, optionally the one or more aliphatic dicarboxylic acid, and the one or more caprolactone monomer for about 0.25 hours to about 100.0 hours, about 0.25 hours to about 95.0 hours, about 0.25 hours to about 90.0 hours, about 0.25 hours to about 85.0 hours, about 0.25 hours to about 80.0 hours, about 0.25 hours to about 75.0 hours, about 0.25 hours to about 70.0 hours, about 0.25 hours to about 65.0 hours, about 0.25 hours to about 60.0 hours, about 0.25 hours to about 55.0 hours, about 0.25 hours to about 50.0 hours, about 0.25 hours to about 45.0 hours, about 0.25 hours to about 40.0 hours, about 0.25 hours to about 35.0 hours, about 0.25 hours to about 30.0 hours, about 0.25 hours to about 25.0 hours, about 0.25 hours to about 20.0 hours, about 0.25 hours to about 15.0 hours, about 0.25 hours to about 10.0 hours, about 0.25 hours to about 9.0 hours, about 0.25 hours to about 8.0 hours, about 0.25 hours to about 7.0 hours, about 0.25 hours to about 6.0 hours, about 0.25 hours to about 5.0 hours, about 0.25 hours to about 4.0 hours, about 0.25 hours to about 3.0 hours, about 0.25 hours to about 2.0 hours, about 0.25 hours to about 1.0 hours, about 0.25 hours to about 0.75 hours, about 0.50 hours to about 100.0 hours, about 0.50 hours to about 95.0 hours, about 0.50 hours to about 90.0 hours, about 0.50 hours to about 85.0 hours, about 0.50 hours to about 80.0 hours, about 0.50 hours to about 75.0 hours, about 0.50 hours to about 70.0 hours, about 0.50 hours to about 65.0 hours, about 0.50 hours to about 60.0 hours, about 0.50 hours to about 55.0 hours, about 0.50 hours to about 50.0 hours, about 0.50 hours to about 45.0 hours, about 0.50 hours to about 40.0 hours, about 0.50 hours to about 35.0 hours, about 0.50 hours to about 30.0 hours, about 0.50 hours to about 25.0 hours, about 0.50 hours to about 20.0 hours, about 0.50 hours to about 15.0 hours, about 0.50 hours to about 10.0 hours, about 0.50 hours to about 9.0 hours, about 0.50 hours to about 8.0 hours, about 0.50 hours to about 7.0 hours, about 0.50 hours to about 6.0 hours, about 0.50 hours to about 5.0 hours, about 0.50 hours to about 4.0 hours, about 0.50 hours to about 3.0 hours, about 0.50 hours to about 2.0 hours, about 0.50 hours to about 1.0 hours, about 1.0 hours to about 100.0 hours, about 1.0 hours to about 95.0 hours, about 1.0 hours to about 90.0 hours, about 1.0 hours to about 85.0 hours, about 1.0 hours to about 80.0 hours, about 1.0 hours to about 75.0 hours, about 1.0 hours to about 70.0 hours, about 1.0 hours to about 65.0 hours, about 1.0 hours to about 60.0 hours, about 1.0 hours to about 55.0 hours, about 1.0 hours to about 50.0 hours, about 1.0 hours to about 45.0 hours, about 1.0 hours to about 40.0 hours, about 1.0 hours to about 35.0 hours, about 1.0 hours to about 30.0 hours, about 1.0 hours to about 25.0 hours, about 1.0 hours to about 20.0 hours, about 1.0 hours to about 15.0 hours, about 1.0 hours to about 10.0 hours, about 1.0 hours to about 9.0 hours, about 1.0 hours to about 8.0 hours, about 1.0 hours to about 7.0 hours, about 1.0 hours to about 6.0 hours, about 1.0 hours to about 5.0 hours, about 1.0 hours to about 4.0 hours, about 1.0 hours to about 3.0 hours, about 5.0 hours to about 100.0 hours, about 5.0 hours to about 95.0 hours, about 5.0 hours to about 90.0 hours, about 5.0 hours to about 85.0 hours, about 5.0 hours to about 80.0 hours, about 5.0 hours to about 75.0 hours, about 5.0 hours to about 70.0 hours, about 5.0 hours to about 65.0 hours, about 5.0 hours to about 60.0 hours, about 5.0 hours to about 55.0 hours, about 5.0 hours to about 50.0 hours, about 5.0 hours to about 45.0 hours, about 5.0 hours to about 40.0 hours, about 5.0 hours to about 35.0 hours, about 5.0 hours to about 30.0 hours, about 5.0 hours to about 25.0 hours, about 5.0 hours to about 20.0 hours, about 5.0 hours to about 15.0 hours, about 5.0 hours to about 10.0 hours, about 10.0 hours to about 100.0 hours, about 10.0 hours to about 95.0 hours, about 10.0 hours to about 90.0 hours, about 10.0 hours to about 85.0 hours, about 10.0 hours to about 80.0 hours, about 10.0 hours to about 75.0 hours, about 10.0 hours to about 70.0 hours, about 10.0 hours to about 65.0 hours, about 10.0 hours to about 60.0 hours, about 10.0 hours to about 55.0 hours, about 10.0 hours to about 50.0 hours, about 10.0 hours to about 45.0 hours, about 10.0 hours to about 40.0 hours, about 10.0 hours to about 35.0 hours, about 10.0 hours to about 30.0 hours, about 10.0 hours to about 25.0 hours, about 10.0 hours to about 20.0 hours, about 10.0 hours to about 15.0 hours, about 15.0 hours to about 100.0 hours, about 15.0 hours to about 95.0 hours, about 15.0 hours to about 90.0 hours, about 15.0 hours to about 85.0 hours, about 15.0 hours to about 80.0 hours, about 15.0 hours to about 75.0 hours, about 15.0 hours to about 70.0 hours, about 15.0 hours to about 65.0 hours, about 15.0 hours to about 60.0 hours, about 15.0 hours to about 55.0 hours, about 15.0 hours to about 50.0 hours, about 15.0 hours to about 45.0 hours, about 15.0 hours to about 40.0 hours, about 15.0 hours to about 35.0 hours, about 15.0 hours to about 30.0 hours, about 15.0 hours to about 25.0 hours, about 15.0 hours to about 20.0 hours, about 20.0 hours to about 100.0 hours, about 20.0 hours to about 95.0 hours, about 20.0 hours to about 90.0 hours, about 20.0 hours to about 85.0 hours, about 20.0 hours to about 80.0 hours, about 20.0 hours to about 75.0 hours, about 20.0 hours to about 70.0 hours, about 20.0 hours to about 65.0 hours, about 20.0 hours to about 60.0 hours, about 20.0 hours to about 55.0 hours, about 20.0 hours to about 50.0 hours, about 20.0 hours to about 45.0 hours, about 20.0 hours to about 40.0 hours, about 20.0 hours to about 35.0 hours, about 20.0 hours to about 30.0 hours, about 20.0 hours to about 25.0 hours, about 25.0 hours to about 100.0 hours, about 25.0 hours to about 95.0 hours, about 25.0 hours to about 90.0 hours, about 25.0 hours to about 85.0 hours, about 25.0 hours to about 80.0 hours, about 25.0 hours to about 75.0 hours, about 25.0 hours to about 70.0 hours, about 25.0 hours to about 65.0 hours, about 25.0 hours to about 60.0 hours, about 25.0 hours to about 55.0 hours, about 25.0 hours to about 50.0 hours, about 25.0 hours to about 45.0 hours, about 25.0 hours to about 40.0 hours, about 25.0 hours to about 35.0 hours, about 25.0 hours to about 30.0 hours, about 30.0 hours to about 100.0 hours, about 30.0 hours to about 95.0 hours, about 30.0 hours to about 90.0 hours, about 30.0 hours to about 85.0 hours, about 30.0 hours to about 80.0 hours, about 30.0 hours to about 75.0 hours, about 30.0 hours to about 70.0 hours, about 30.0 hours to about 65.0 hours, about 30.0 hours to about 60.0 hours, about 30.0 hours to about 55.0 hours, about 30.0 hours to about 50.0 hours, about 30.0 hours to about 45.0 hours, about 30.0 hours to about 40.0 hours, about 30.0 hours to about 35.0 hours, about 35.0 hours to about 100.0 hours, about 35.0 hours to about 95.0 hours, about 35.0 hours to about 90.0 hours, about 35.0 hours to about 85.0 hours, about 35.0 hours to about 80.0 hours, about 35.0 hours to about 75.0 hours, about 35.0 hours to about 70.0 hours, about 35.0 hours to about 65.0 hours, about 35.0 hours to about 60.0 hours, about 35.0 hours to about 55.0 hours, about 35.0 hours to about 50.0 hours, about 35.0 hours to about 45.0 hours, about 35.0 hours to about 40.0 hours, about 40.0 hours to about 100.0 hours, about 40.0 hours to about 95.0 hours, about 40.0 hours to about 90.0 hours, about 40.0 hours to about 85.0 hours, about 40.0 hours to about 80.0 hours, about 40.0 hours to about 75.0 hours, about 40.0 hours to about 70.0 hours, about 40.0 hours to about 65.0 hours, about 40.0 hours to about 60.0 hours, about 40.0 hours to about 55.0 hours, about 40.0 hours to about 50.0 hours, about 40.0 hours to about 45.0 hours, about 45.0 hours to about 100.0 hours, about 45.0 hours to about 95.0 hours, about 45.0 hours to about 90.0 hours, about 45.0 hours to about 85.0 hours, about 45.0 hours to about 80.0 hours, about 45.0 hours to about 75.0 hours, about 45.0 hours to about 70.0 hours, about 45.0 hours to about 65.0 hours, about 45.0 hours to about 60.0 hours, about 45.0 hours to about 55.0 hours, about 45.0 hours to about 50.0 hours, about 50.0 hours to about 100.0 hours, about 50.0 hours to about 95.0 hours, about 50.0 hours to about 90.0 hours, about 50.0 hours to about 85.0 hours, about 50.0 hours to about 80.0 hours, about 50.0 hours to about 75.0 hours, about 50.0 hours to about 70.0 hours, about 50.0 hours to about 65.0 hours, about 50.0 hours to about 60.0 hours, about 50.0 hours to about 55.0 hours, about 55.0 hours to about 100.0 hours, about 55.0 hours to about 95.0 hours, about 55.0 hours to about 90.0 hours, about 55.0 hours to about 85.0 hours, about 55.0 hours to about 80.0 hours, about 55.0 hours to about 75.0 hours, about 55.0 hours to about 70.0 hours, about 55.0 hours to about 65.0 hours, about 55.0 hours to about 60.0 hours, about 60.0 hours to about 100.0 hours, about 60.0 hours to about 95.0 hours, about 60.0 hours to about 90.0 hours, about 60.0 hours to about 85.0 hours, about 60.0 hours to about 80.0 hours, about 60.0 hours to about 75.0 hours, about 60.0 hours to about 70.0 hours, about 60.0 hours to about 65.0 hours, about 65.0 hours to about 100.0 hours, about 65.0 hours to about 95.0 hours, about 65.0 hours to about 90.0 hours, about 65.0 hours to about 85.0 hours, about 65.0 hours to about 80.0 hours, about 65.0 hours to about 75.0 hours, about 65.0 hours to about 70.0 hours, about 70.0 hours to about 100.0 hours, about 70.0 hours to about 95.0 hours, about 70.0 hours to about 90.0 hours, about 70.0 hours to about 85.0 hours, about 70.0 hours to about 80.0 hours, about 70.0 hours to about 75.0 hours, about 75.0 hours to about 100.0 hours, about 75.0 hours to about 95.0 hours, about 75.0 hours to about 90.0 hours, about 75.0 hours to about 85.0 hours, about 75.0 hours to about 80.0 hours, about 80.0 hours to about 100.0 hours, about 80.0 hours to about 95.0 hours, about 80.0 hours to about 90.0 hours, about 80.0 hours to about 85.0 hours, about 85.0 hours to about 100.0 hours, about 85.0 hours to about 95.0 hours, about 85.0 hours to about 90.0 hours, about 90.0 hours to about 100.0 hours, about 90.0 hours to about 95.0 hours, or about 95.0 hours to about 100.0 hours.

For example, in any aspect or embodiment described herein, reacting the one or more cyclic aliphatic initiator, optionally the one or more aliphatic dicarboxylic acid, and the one or more caprolactone monomer is performed at a pressure of about 0.0 millibar to about 1,000 millibar, about 0.1 to about 1,000 millibar, or about 0.2 millibar to about 1,000 millibar (e.g., about 0.0 millibar to about 1,000 millibar, about 0.0 millibar to about 900 millibar, about 0.0 millibar to about 800 millibar, about 0.0 millibar to about 700 millibar, about 0.0 millibar to about 600 millibar, about 0.0 millibar to about 500 millibar, about 0.0 millibar to about 400 millibar, about 0.0 millibar to about 300 millibar, about 0.0 millibar to about 200 millibar, about 0.0 millibar to about 100 millibar, about 0.1 millibar to about 1,000 millibar, about 0.1 millibar to about 900 millibar, about 0.1 millibar to about 800 millibar, about 0.1 millibar to about 700 millibar, about 0.1 millibar to about 600 millibar, about 0.1 millibar to about 500 millibar, about 0.1 millibar to about 400 millibar, about 0.1 millibar to about 300 millibar, about 0.1 millibar to about 200 millibar, about 0.1 millibar to about 100 millibar, about 0.2 millibar to about 1,000 millibar, about 0.2 millibar to about 900 millibar, about 0.2 millibar to about 800 millibar, about 0.2 millibar to about 700 millibar, about 0.2 millibar to about 600 millibar, about 0.2 millibar to about 500 millibar, about 0.2 millibar to about 400 millibar, about 0.2 millibar to about 300 millibar, about 0.2 millibar to about 200 millibar, about 0.2 millibar to about 100 millibar, about 100 millibar to about 1,000 millibar, about 100 millibar to about 900 millibar, about 100 millibar to about 800 millibar, about 100 millibar to about 700 millibar, about 100 millibar to about 600 millibar, about 100 millibar to about 500 millibar, about 100 millibar to about 400 millibar, about 100 millibar to about 300 millibar, about 100 millibar to about 200 millibar, about 200 millibar to about 1,000 millibar, about 200 millibar to about 900 millibar, about 200 millibar to about 800 millibar, about 200 millibar to about 700 millibar, about 200 millibar to about 600 millibar, about 200 millibar to about 500 millibar, about 200 millibar to about 400 millibar, about 200 millibar to about 300 millibar, about 300 millibar to about 1,000 millibar, about 300 millibar to about 900 millibar, about 300 millibar to about 800 millibar, about 300 millibar to about 700 millibar, about 300 millibar to about 600 millibar, about 300 millibar to about 500 millibar, about 300 millibar to about 400 millibar, about 400 millibar to about 1,000 millibar, about 400 millibar to about 900 millibar, about 400 millibar to about 800 millibar, about 400 millibar to about 700 millibar, about 400 millibar to about 600 millibar, about 400 millibar to about 500 millibar, about 500 millibar to about 1,000 millibar, about 500 millibar to about 900 millibar, about 500 millibar to about 800 millibar, about 500 millibar to about 700 millibar, about 500 millibar to about 600 millibar, about 600 millibar to about 1,000 millibar, about 600 millibar to about 900 millibar, about 600 millibar to about 800 millibar, about 600 millibar to about 700 millibar, about 700 millibar to about 1,000 millibar, about 700 millibar to about 900 millibar, about 700 millibar to about 800 millibar, about 800 millibar to about 1,000 millibar, about 800 millibar to about 900 millibar, or about 900 millibar to about 1,000 millibar).

In any aspect or embodiment described herein, the catalyst is a catalyst for ring-opening polymerization. For example, in any aspect or embodiment described herein, the catalyst or the catalyst for ring-opening polymerization includes, consists essentially of, or consists of, at least one of a zinc-based catalyst (such as, zinc lactate, zinc oxide, zinc powder, diethyl zinc, or a combination thereof), a tin-based catalyst (such as, tin lactate, tin oxide, tin dioxide, stannous oxide, stannous lactate, stannous octoate, stannous chloride, tin powder, or a combination thereof), a zirconium-based catalyst, a titanium-based catalyst (such as, tetrabutyl titanate), or a combination thereof.

In any aspect or embodiment described herein, the process further comprises, consists essentially of, or consists of, prior to reacting, removing water by heating the one or more cyclic aliphatic initiator, the one or more aliphatic dicarboxylic acid, the one or more caprolactone monomer, or a mixture thereof, at a temperature of about 40° C. to about 110° C. For example, in any aspect or embodiment described herein, the process further comprises, consists essentially of, or consists of, prior to reacting, removing water by heating the one or more cyclic aliphatic initiator, the one or more aliphatic dicarboxylic acid, the one or more caprolactone monomer, or a mixture thereof, is performed at a temperature of about 40° C. to about 110° C., about 40° C. to about 100° C., about 40° C. to about 90° C., about 40° C. to about 80° C., about 40° C. to about 70° C., about 40° C. to about 60° C., about 40° C. to about 50° C., about 50° C. to about 110° C., about 50° C. to about 100° C., about 50° C. to about 90° C., about 50° C. to about 80° C., about 50° C. to about 70° C., about 50° C. to about 60° C., about 60° C. to about 110° C., about 60° C. to about 100° C., about 60° C. to about 90° C., about 60° C. to about 80° C., about 60° C. to about 70° C., about 70° C. to about 110° C., about 70° C. to about 100° C., about 70° C. to about 90° C., about 70° C. to about 80° C., about 80° C. to about 110° C., about 80° C. to about 100° C., about 80° C. to about 90° C., about 90° C. to about 110° C., about 90° C. to about 100° C., or about 100° C. to about 110° C.

In any aspect or embodiment described herein, the process further comprises, consists essentially of, or consists of, removing water by heating the polycaprolactone composition, the polycaprolactone, the reaction product, or a combination thereof, at a temperature of about 50° C. to about 110° C. For example, in any aspect or embodiment described herein, the process further comprises, consists essentially of, or consists of, removing water by heating the polycaprolactone composition, the polycaprolactone, the reaction product, or a combination thereof, at a temperature of about 50° C. to about 110° C., about 50° C. to about 100° C., about 50° C. to about 90° C., about 50° C. to about 80° C., about 50° C. to about 70° C., about 50° C. to about 60° C., about 60° C. to about 110° C., about 60° C. to about 100° C., about 60° C. to about 90° C., about 60° C. to about 80° C., about 60° C. to about 70° C., about 70° C. to about 110° C., about 70° C. to about 100° C., about 70° C. to about 90° C., about 70° C. to about 80° C., about 80° C. to about 110° C., about 80° C. to about 100° C., about 80° C. to about 90° C., about 90° C. to about 110° C., about 90° C. to about 100° C., or about 100° C. to about 110° C.

In any aspect or embodiment described herein, at least one of: (a) the one or more cyclic aliphatic initiator is a polyol (e.g., a diol); (b) the one or more cyclic aliphatic initiator comprises, consists essentially of, or consists of: (i) a cyclic group comprises, consists essentially of, or consists of, at least one of (1) a monocyclic aliphatic group, (2) a fused cyclic ring system comprising two or more (e.g., 2, 3, or 4) aliphatic rings, (3) a spirocyclic ring system comprising two or more (e.g., 2, 3, or 4) aliphatic rings, (4) a bridged cyclic ring system comprising two or more (e.g., 2, 3, or 4) aliphatic rings, or (5) a combination thereof; and (ii) two or more (e.g., 2, 3, 4, or more) hydroxyl containing groups (e.g., one or more methoxy and/or ethoxy, two or more hydroxyl containing groups attached to disparate locations of the cyclic group, or a combination thereof); or (c) a combination thereof. For example, in any aspect or embodiment described herein, the one or more cyclic aliphatic initiator is a polyol (e.g., a diol). By way of further example, in any aspect or embodiment described herein, the one or more cyclic aliphatic initiator comprises, consists essentially of, or consists of: (i) a cyclic group comprises, consists essentially of, or consists of, at least one of (1) a monocyclic aliphatic group, (2) a fused cyclic ring system comprising two or more (e.g., 2, 3, or 4) aliphatic rings, (3) a spirocyclic ring system comprising two or more (e.g., 2, 3, or 4) aliphatic rings, (4) a bridged cyclic ring system comprising two or more (e.g., 2, 3, or 4) aliphatic rings, or (5) a combination thereof; and (ii) two or more (e.g., 2, 3, 4, or more) hydroxyl containing groups (e.g., one or more methoxy and/or ethoxy, two or more hydroxyl containing groups attached to disparate locations of the cyclic group, or a combination thereof).

In any aspect or embodiment described herein, at least one of (a) the cyclic group comprises, consists essentially of, or consists of, 5 to 20 carbon atoms (e.g., 5 to 15 carbon atoms or 6 to 10 carbon atoms); (b) the two or more hydroxyl containing groups comprises, consists essentially of, or consists of, (i) one or more (e.g., two or more, 2, 3, 4, or more) primary hydroxyl groups, (ii) one or more (e.g., two or more, 2, 3, 4, or more) alkoxyl group (e.g., C₁₋₅ or C₁₋₃ alkoxyl group, such as methanol and/or ethanol), or (iii) a combination thereof; or (c) a combination thereof. For example, in any aspect or embodiment described herein, the cyclic group comprises, consists essentially of, or consists of, 5 to 20 carbon atoms (e.g., 5 to 15 carbon atoms or 6 to 10 carbon atoms). By way of further example, in any aspect or embodiment described herein, the two or more hydroxyl containing groups comprises, consists essentially of, or consists of, at least one of (i) one or more (e.g., two or more, 2, 3, 4, or more) primary hydroxyl groups, (ii) one or more (e.g., two or more, 2, 3, 4, or more) alkoxyl group (e.g., C₁₋₅ or C₁₋₃ alkoxyl group, such as methanol and/or ethanol), or (iii) a combination thereof.

In any aspect or embodiment described herein, the one or more cyclic aliphatic initiator comprises, consists essentially of, or consists of, at least one of cyclohexanedimethanol (e.g., 1,1-cyclohexanedimethanol, 1,2-cyclohexanedimethanol, 1,3-cyclohexanedimethanol, or 1, 4-cyclohexanedimethanol), pentasprioglycol, a tricyclodecane polyol (e.g., a diol, tricyclodecanedimethanol, or a combination thereof), or a combination thereof. In any aspect or embodiment described herein, the one or more cyclic aliphatic initiator comprises, consists essentially of, or consists of, at least one cyclohexanedimethanol (e.g., 1,1-cyclohexanedimethanol, 1,2-cyclohexanedimethanol, 1,3-cyclohexanedimethanol, 1, 4-cyclohexanedimethanol, or a combination thereof). In any aspect or embodiment described herein, the one or more cyclic aliphatic initiator comprises, consists essentially of, or consists of, at least one of pentasprioglycol, a tricyclodecane polyol (e.g., a diol, tricyclodecanedimethanol, or a combination thereof), or a combination thereof.

In any aspect or embodiment described herein, the one or more caprolactone monomer comprises, consists essentially of, or consists of an unsubstituted caprolactone (e.g., unsubstituted ε-caprolactone).

In any aspect or embodiment described herein, the one or more caprolactone monomer comprises, consists essentially of, or consists of a substituted caprolactone (e.g., substituted ε-caprolactone).

In any aspect or embodiment described herein, the polycaprolactone or polycaprolactone polyol has an average molecular weight of about 400 g/mol to about 10,000 g/mol, about 400 g/mol to about 9,000 g/mol, about 400 g/mol to about 8,000 g/mol, about 400 g/mol to about 7,000 g/mol, about 400 g/mol to about 6,000 g/mol, about 400 g/mol to about 5,000 g/mol, about 500 g/mol to about 4,000 g/mol, about 400 g/mol to about 3,000 g/mol, about 400 g/mol to about 2,000 g/mol, about 1,000 g/mol to about 10,000 g/mol, about 1,000 g/mol to about 9,000 g/mol, about 1,000 g/mol to about 8,000 g/mol, about 1,000 g/mol to about 7,000 g/mol, about 1,000 g/mol to about 6,000 g/mol, about 1,000 g/mol to about 5,000 g/mol, about 1,000 g/mol to about 4,000 g/mol, about 1,000 g/mol to about 3,000 g/mol, about 1,000 g/mol to about 2,000 g/mol, about 1,500 g/mol to about 10,000 g/mol, about 1,500 g/mol to about 9,000 g/mol, about 1,500 g/mol to about 8,000 g/mol, about 1,500 g/mol to about 7,000 g/mol, about 1,500 g/mol to about 6,000 g/mol, about 1,500 g/mol to about 5,000 g/mol, about 1,500 g/mol to about 4,000 g/mol, about 1,500 g/mol to about 3,000 g/mol, about 2,000 g/mol to about 10,000 g/mol, about 2,000 g/mol to about 9,000 g/mol, about 2,000 g/mol to about 8,000 g/mol, about 2,000 g/mol to about 7,000 g/mol, about 2,000 g/mol to about 6,000 g/mol, about 2,000 g/mol to about 5,000 g/mol, about 2,000 g/mol to about 4,000 g/mol, about 2,000 g/mol to about 3,000 g/mol, about 2,500 g/mol to about 10,000 g/mol, about 2,500 g/mol to about 9,000 g/mol, about 2,500 g/mol to about 8,000 g/mol, about 2,500 g/mol to about 7,000 g/mol, about 2,500 g/mol to about 6,000 g/mol, about 2,500 g/mol to about 5,000 g/mol, about 2,500 g/mol to about 4,000 g/mol, about 3,000 g/mol to about 10,000 g/mol, about 3,000 g/mol to about 9,000 g/mol, about 3,000 g/mol to about 8,000 g/mol, about 3,000 g/mol to about 7,000 g/mol, about 3,000 g/mol to about 6,000 g/mol, about 3,000 g/mol to about 5,000 g/mol, about 3,000 g/mol to about 4,000 g/mol, about 3,500 g/mol to about 10,000 g/mol, about 3,500 g/mol to about 9,000 g/mol, about 3,500 g/mol to about 8,000 g/mol, about 3,500 g/mol to about 7,000 g/mol, about 3,500 g/mol to about 6,000 g/mol, about 3,500 g/mol to about 5,000 g/mol, about 4,000 g/mol to about 10,000 g/mol, about 4,000 g/mol to about 9,000 g/mol, about 4,000 g/mol to about 8,000 g/mol, about 4,000 g/mol to about 7,000 g/mol, about 4,000 g/mol to about 6,000 g/mol, about 4,000 g/mol to about 5,000 g/mol, about 4,500 g/mol to about 10,000 g/mol, about 4,500 g/mol to about 9,000 g/mol, about 4,500 g/mol to about 8,000 g/mol, about 4,500 g/mol to about 7,000 g/mol, about 4,500 g/mol to about 6,000 g/mol, about 5,000 g/mol to about 10,000 g/mol, about 5,000 g/mol to about 9,000 g/mol, about 5,000 g/mol to about 8,000 g/mol, about 5,000 g/mol to about 7,000 g/mol, about 5,000 g/mol to about 6,000 g/mol, about 5,500 g/mol to about 10,000 g/mol, about 5,500 g/mol to about 9,000 g/mol, about 5,500 g/mol to about 8,000 g/mol, about 5,500 g/mol to about 7,000 g/mol, about 6,000 g/mol to about 10,000 g/mol, about 6,000 g/mol to about 9,000 g/mol, about 6,000 g/mol to about 8,000 g/mol, about 6,000 g/mol to about 7,000 g/mol, about 6,500 g/mol to about 10,000 g/mol, about 6,500 g/mol to about 9,000 g/mol, about 6,500 g/mol to about 8,000 g/mol, about 7,000 g/mol to about 10,000 g/mol, about 7,000 g/mol to about 9,000 g/mol, about 7,000 g/mol to about 8,000 g/mol, about 7,500 g/mol to about 10,000 g/mol, about 7,500 g/mol to about 9,000 g/mol, about 8,000 g/mol to about 10,000 g/mol, about 8,000 g/mol to about 9,000 g/mol, or about 8,500 g/mol to about 10,000 g/mol.

In any aspect or embodiment described herein, the polycaprolactone or polycaprolactone polyol has an average molecular weight of about 500 g/mol to about 4000 g/mol (e.g., about 500 g/mol to about 2000 g/mol or about 750 g/mol or about 1,750 g/mol). In any aspect or embodiment described herein, the polycaprolactone or polycaprolactone polyol has an average molecular weight of about 1000 g/mol to about 4000 g/mol (e.g., about 1000 g/mol to about 2000 g/mol).

### Polymeric Compositions and Methods of Making the Same

A further aspect of the present disclosure provides a polymeric composition comprising, consisting essentially of, or consists of, a reaction product of: (a) one or more (e.g., 1, 2, 3, 4, or more) polycaprolactone composition (e.g., polycaprolactone polyol composition) or polycaprolactone (e.g., polycaprolactone polyol) of the present disclosure, or produced according to the method of claim 12, that is present in the range of about 5.0 wt % to about 95.0 wt % of the polymeric composition, wherein the one or more polycaprolactone composition or polycaprolactone has an average molecular weight of about 400 g/mol to about 10,000 g/mol; (b) one or more (e.g., 1, 2, 3, 4, or more) diisocyanate that is present in the range of about 5.0 wt % to about 95.0 wt % of the polymeric composition; (c) optionally one or more (e.g., 1, 2, 3, 4, or more) additional polyol (e.g., an additional polyol other than the polycaprolactone composition of the present disclosure or the polycaprolactone of the present disclosure) that is present in the range of about 0.0 wt % to about 90.0 wt % of the polymeric composition; and (d) optionally one or more (e.g., 1, 2, 3, 4, or more) chain extender, wherein the one or more chain extender comprises, consists essentially of, or consists of, at least one of, one or more (e.g., 1, 2, 3, 4, or more) diol chain extender, one or more (e.g., 1, 2, 3, 4, or more) diamine chain extender, or a combination thereof, wherein the one or more chain extender has a molecular weight of about 60.0 g/mol to about 600.0 g/mol, with an NCO:OH molar ratio of about 0.9:1 to about 2:1, and is present in a range of about 0.0 wt % to about 25.0 wt % of the polymeric composition.

An additional aspect of the present disclosure provides a method of making or producing the polymeric composition of the present disclosure, the method comprising, consisting essentially of, or consists of, reacting the one or more polycaprolactone composition (e.g., polycaprolactone polyol composition) or polycaprolactone (e.g., polycaprolactone polyol) of the present disclosure, the one or more diisocyanate, optionally one or more polyol (e.g., an additional polyol other than the polycaprolactone composition of the present disclosure or the polycaprolactone of the present disclosure), and optionally, the one or more chain extender.

Another aspect of the present disclosure provides a thermoplastic polyurethane, a thermoplastic polyurethane elastomer, a hot cast elastomer, a cold cast elastomer, a slabstock polyurethane foam, a moulded polyurethane foam, a microcellular polyurethane foam, a polyurethane dispersion in aqueous or organic media, a polyurethane adhesive, a one-component polyurethane coating, a two-component polyurethane coating, an additive manufacturing composition/resin, or a polyurethane sealant, comprising, consisting essentially of, or consisting of, the one or more polycaprolactone composition (e.g., polycaprolactone polyol composition) or polycaprolactone (e.g., polycaprolactone polyol) of the present disclosure, the polycaprolactone composition (e.g., polycaprolactone polyol composition) or polycaprolactone (e.g., polycaprolactone polyol) prepared according to the method of the present disclosure, the polymeric composition of the present disclosure, or a polymeric composition prepared according to the method of the present disclosure.

In any aspect or embodiment described herein, at least one of (a) the one or more polycaprolactone composition (e.g., polycaprolactone polyol composition) or polycaprolactone (e.g., polycaprolactone polyol) is present in the range of about 20.0 wt % to about 80.0 wt % (e.g., about 40.0 wt % to about 60.0 wt %) of the polymeric composition; (b) the one or more diisocyanate is present in the range of about 20.0 wt % to about 80.0 wt % (e.g., about 30.0 wt % to about 60.0 wt %, about 30.0 wt % to about 50.0 wt %, or about 40.0 wt % to about 60.0 wt %) of the polymeric composition; (c) the one or more chain extender is present in the range of about 0.0 wt % to about 15.0 wt % (e.g., about 5.0 wt % to about 15.0 wt %) of the polymeric composition; or (d) a combination thereof.

In any aspect or embodiment described herein, at least one of (a) the one or more polycaprolactone composition (e.g., polycaprolactone polyol composition) or polycaprolactone (e.g., polycaprolactone polyol) is present in the range of about 5.0 wt % to about 80.0 wt % (e.g., about 40.0 wt % to about 60.0 wt %) of the polymeric composition; (b) the one or more additional polyol is present in the range of up to about 75.0 wt % (e.g., up to about 55.0 wt %, about 15.0 wt % to about 75.0 wt %, or about 35.0 wt % to about 55.0 wt %) of the polymeric composition; (c) the combination of the one or more polycaprolactone composition and the one or more additional polyol is present in the range of about 20.0 wt % to about 80.0 wt % (e.g., about 40.0 wt % to about 60.0 wt %) of the polymeric composition; (d) the one or more diisocyanate is present in the range of about 20.0 wt % to about 80.0 wt % (e.g., about 30.0 wt % to about 60.0 wt %, about 30.0 wt % to about 50.0 wt %, or about 40.0 wt % to about 60.0 wt %) of the polymeric composition; (e) the one or more diol chain extender, the one or more diamine chain extender, or the combination thereof, is present in the range of about 0.0 wt % to about 15.0 wt % (e.g., about 5.0 wt % to about 15.0 wt %) of the polymeric composition; or (f) a combination thereof.

In any aspect or embodiment described herein, the one or more polycaprolactone composition (e.g., polycaprolactone polyol composition) of the present disclosure or polycaprolactone (e.g., polycaprolactone polyol) of the present disclosure is present in the range of about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, or about 85.0 wt % to about 95.0 wt % of the total molecular weight of the polymeric composition.

In any aspect or embodiment described herein, the one or more diisocyanate is present in the range of about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, or about 85.0 wt % to about 95.0 wt % of the total molecular weight of the polymeric composition.

In any aspect or embodiment described herein, the one or more chain extender has a molecular weight of about 60.0 g/mol to about 500.0 g/mol, about 60.0 g/mol to about 400.0 g/mol, about 60.0 g/mol to about 300.0 g/mol, about 60.0 g/mol to about 200.0 g/mol, about 60.0 g/mol to about 160.0 g/mol, about 100.0 g/mol to about 500.0 g/mol, about 100.0 g/mol to about 400.0 g/mol, about 100.0 g/mol to about 300.0 g/mol, about 100.0 g/mol to about 200.0 g/mol, about 200.0 g/mol to about 500.0 g/mol, about 200.0 g/mol to about 400.0 g/mol, about 200.0 g/mol to about 300.0 g/mol, about 300.0 g/mol to about 500.0 g/mol, about 300.0 g/mol to about 400.0 g/mol, or about 400.0 g/mol to about 500.0 g/mol.

In any aspect or embodiment described herein, the one or more chain extender has an NCO:OH molar ratio of about 0.9:1 to about 2:1, about 0.9:1 to about 1.8:1, about 0.9:1 to about 1.6:1, about 0.9:1 to about 1.4:1, about 0.9:1 to about 1.2:1, about 0.9:1 to about 1:1, about 1:1 to about 2:1, about 1:1 to about 1.8:1, about 1:1 to about 1.6:1, about 1:1 to about 1.4:1, about 1:1 to about 1.2:1, about 1.2:1 to about 2:1, about 1.2:1 to about 1.8:1, about 1.2:1 to about 1.6:1, about 1.2:1 to about 1.4:1, about 1.4:1 to about 2:1, about 1.4:1 to about 1.8:1, about 1.4:1 to about 1.6:1, about 1.6:1 to about 2:1, about 1.6:1 to about 1.8:1, or about 1.8:1 to about 2:1.

In any aspect or embodiment described herein, the one or more chain extender is present in a range of about 0.0 wt % to about 25.0 wt %, about 0.0 wt % to about 20.0 wt %, about 0.0 wt % to about 15.0 wt %, about 0.0 wt % to about 10.0 wt %, about 0.0 wt % to about 5.0 wt %, about 5.0 wt % to about 25.0 wt %, about 5.0 wt % to about 20.0 wt %, about 5.0 wt % to about 15.0 wt %, about 5.0 wt % to about 10.0 wt %, about 10.0 wt % to about 25.0 wt %, about 10.0 wt % to about 20.0 wt %, about 10.0 wt % to about 15.0 wt %, about 15.0 wt % to about 25.0 wt %, about 15.0 wt % to about 20.0 wt %, or about 20.0 wt % to about 25.0 wt % of the total molecular weight of the polymeric composition.

In any aspect or embodiment described herein, the one or more diisocyanate comprises, consists essentially of, or is at least one of 4,4′-diphenylmethane diisocyanate, isophorone diisocyanate, bimethylene diisocyanate, trimethylene diisocyanate (e.g., 1,3-trimethylene diisocyanate, 2,3-trimethylene diisocyanate, 1,2-trimethylene diisocyanate, 2,2-trimethylene diisocyanate, or a mixture thereof), tetramethylene diisocyanate (e.g., 1,4-tetramethylene diisocyanate, 1,3-tetramethylene diisocyanate, 1,2-tetramethylene diisocyanate, 2,3-tetramethylene diisocyanate, 1,1-tetramethylene diisocyanate, 2,2-tetramethylene diisocyanate, or a mixture thereof), pentamethylene diisocyanate (e.g., 1,5-pentamethylene diisocyanate, 1,4-pentamethylene diisocyanate, 1,3-pentamethylene diisocyanate, 1,2-pentamethylene diisocyanate, 2,3-pentamethylene diisocyanate, 2,4-pentamethylene diisocyanate, 3,4-pentamethylene diisocyanate, 3,5-pentamethylene diisocyanate, 1,1-pentamethylene diisocyanate, 2,2-pentamethylene diisocyanate, 3,3-pentamethylene diisocyanate, or a mixture thereof), hexamethylene diisocyanate (e.g., 1,6-hexamethylene diisocyanate, 1,5-hexamethylene diisocyanate, 1,4-hexamethylene diisocyanate, 1,3-hexamethylene diisocyanate, 1,2-hexamethylene diisocyanate, 2,3-hexamethylene diisocyanate, 2,4-hexamethylene diisocyanate, 2,5-hexamethylene diisocyanate, 3,4-hexamethylene diisocyanate, 3,5-hexamethylene diisocyanate, 4,5-hexamethylene diisocyanate, 1,1-hexamethylene diisocyanate, 2,2-hexamethylene diisocyanate, 3,3-hexamethylene diisocyanate, or a mixture thereof), heptamethylene diisocyanate (e.g., 1,7-heptamethylene diisocyanate, 1,6-heptamethylene diisocyanate, 1,5-heptamethylene diisocyanate, 1,4-heptamethylene diisocyanate, 1,3-heptamethylene diisocyanate, 1,2-heptamethylene diisocyanate, 2,3-heptamethylene diisocyanate, 2,4-heptamethylene diisocyanate, 2,5-heptamethylene diisocyanate, 2,6-heptamethylene diisocyanate, 3,3-heptamethylene diisocyanate, 3,4-heptamethylene diisocyanate, 1,1-heptamethylene diisocyanate, 2,2-heptamethylene diisocyanate, 3,3-heptamethylene diisocyanate, 4,4-heptamethylene diisocyanate, or a mixture thereof), toluene diisocyanate (e.g., toluene-2,4-diisocyanate, toluene-2,6-diisocyanate, or a mixture thereof), naphthylene diisocyanate (e.g., 1,2-naphthylene diisocyanate, 1,3-naphthylene diisocyanate, 1,4-naphthylene diisocyanate, 1,5-naphthylene diisocyanate, 1,6-naphthylene diisocyanate, 1,7-naphthylene diisocyanate, 1,8-naphthylene diisocyanate, or a mixture thereof), cyclohexylmethane diisocyanate (e.g., 1,4-cyclohexylmethane diisocyanate, 2,4-cyclohexylmethane diisocyanate, 3,4-cyclohexylmethane diisocyanate, 4,4-cyclohexylmethane diisocyanate, or a mixture thereof), dicyclohexylmethane diisocyanate (e.g., 4,4′-dicyclohexylmethane diisocyanate, 1,4-dicyclohexylmethane diisocyanate, or a mixture thereof), or a mixture thereof.

In any aspect or embodiment described herein, the one or more diisocyanate comprises, consists essentially of, or is at least one of 4,4′-diphenylmethanediisocyanate, isophorone diisocyanate, 1,6-hexamethylene diisocyanate, toluene-2,4-diisocyanate, 1,5-napthylene diisocyanate, 4,4′-dicyclohexylmethane diisocyanate, or a mixture thereof.

In any aspect or embodiment described herein, the one or more diol chain extender comprises, consists essentially of, or is an aliphatic diol or an aromatic diol.

In any aspect or embodiment described herein, the one or more diol chain extender comprises, consists essentially of, or is at least one of an alkylene oxide or glycol, ethylene glycol, propanediol (e.g., 1,3-propanediol, 1,2-propanediol, 1,1-propanediol, 2,2-propanediol, or a mixture thereof), butanediol (e.g., 1,4-butanediol, 1,3-butanediol, 1,2-butanediol, 2,3-butanediol, 1,1-butanediol, 2,2-butanediol, or a mixture thereof), pentadiol (e.g., 1,5-pentadiol, 1,4-pentadiol, 1,3-pentadiol, 1,2-pentadiol, 2,3-pentadiol, 2,4-pentadiol, 3,4-pentadiol, 3,5-hexanediol, 1,1-pentadiol, 2,2-pentadiol, 3,3-pentadiol, or a mixture thereof), hexanediol (e.g., 1,6-hexanediol, 1,5-hexanediol, 1,4-hexanediol, 1,3-hexanediol, 1,2-hexanediol, 2,3-hexanediol, 2,4-hexanediol, 2,5-hexanediol, 3,4-hexanediol, 3,5-hexanediol, 4,5-hexanediol, 1,1-hexanediol, 2,2-hexanediol, 3,3-hexanediol, or a mixture thereof), heptadiol (e.g., 1,7-heptadiol, 1,6-heptadiol, 1,5-heptadiol, 1,4-heptadiol, 1,3-heptadiol, 1,2-heptadiol, 2,3-heptadiol, 2,4-heptadiol, 2,5-heptadiol, 2, 6-heptadiol, 3,3-heptadiol, 3,4-heptadiol, 1,1-heptadiol, 2,2-heptadiol, 3,3-heptadiol, 4,4-heptadiol, or a mixture thereof), dihydroxybenzene (e.g., 1,2-dihydroxybenzene, 1,3-dihydroxybenzene, 1,4-dihydroxybenzene, or a mixture thereof), di(hydroxyethyl)-hydroxyquinone (e.g., 1,4-di-(betahydroxyethyl)-hydroxyquinone, 2,5-di-(hydroxyethyl)-hydroxyquinone, 2,3-di-(hydroxyethyl)-hydroxyquinone, 3,5-di-(hydroxyethyl)-hydroxyquinone, or mixtures thereof), di(hydroxymethyl)-hydroxyquinone (e.g., 2,5-di-(hydroxyethyl)-hydroxyquinone, 2,3-di-(hydroxymethyl)-hydroxyquinone, 3,5-di-(hydroxymethyl)-hydroxyquinone, or mixtures thereof), di-(hydroxyethyl)-bisphenol A (e.g., 1,4-di-(betahydroxyethyl)-bisphenol A, 1,3-di-(betahydroxyethyl)-bisphenol A, 1,2-di-(betahydroxyethyl)-bisphenol A, 1,5-di-(betahydroxyethyl)-bisphenol A, 2,3-di-(betahydroxyethyl)-bisphenol A, 2,4-di-(betahydroxyethyl)-bisphenol A, 2,5-di-(betahydroxyethyl)-bisphenol A, 2,6-di-(betahydroxyethyl)-bisphenol A, 3,4-di-(betahydroxyethyl)-bisphenol A), 3,5-di-(betahydroxyethyl)-bisphenol A), or a mixture thereof.

In any aspect or embodiment described herein, the one or more diol chain extender comprises, consists essentially of, or is at least one of ethylene glycol, 1,4-butanediol, 1,6-hexanediol, 1,4-di-(betahydroxyethyl)-hydroxyquinone, 1,4-di-(betahydroxyethyl)-bisphenol A, or a mixture thereof.

In any aspect or embodiment described herein, the one or more diamine chain extender comprises, consists essentially of, or is at least one of diaminodiphenylmethane (e.g., 2,2′-diaminodiphenylmethane, 2,3′-diaminodiphenylmethane, 2,4′-diaminodiphenylmethane, 2,5′-diaminodiphenylmethane, 2,6′-diaminodiphenylmethane, 3,4′-diaminodiphenylmethane, 3,5′-diaminodiphenylmethane, 3,6′-diaminodiphenylmethane, 4,4′-diaminodiphenylmethane, 4,5′-diaminodiphenylmethane, 4,6′-diaminodiphenylmethane, 5,6′-diaminodiphenylmethane, or a mixture thereof), dichloro-diaminodiphenylmethane (e.g., 2,2′-dichloro-3,3′-diaminodiphenylmethane, 2,2′-dichloro-4,4′-diaminodiphenylmethane, 5,5′-dichloro-3,3′-diaminodiphenylmethane, 2,2′-dichloro-6,6′-diaminodiphenylmethane, 2,2′-dichloro-3,4′-diaminodiphenylmethane, 2,2′-dichloro-3,5′-diaminodiphenylmethane, 2,2′-dichloro-3,6′-diaminodiphenylmethane, 2,2′-dichloro-4,5′-diaminodiphenylmethane, 2,2′-dichloro-4,6′-diaminodiphenylmethane, 2,2′-dichloro-5,6′-diaminodiphenylmethane, 3,3′-dichloro-2,2′-diaminodiphenylmethane, 3,3′-dichloro-4,4′-diaminodiphenylmethane, 3,3′-dichloro-5,5′-diaminodiphenylmethane, 3,3′-dichloro-6,6′-diaminodiphenylmethane, 3,3′-dichloro-2,5′-diaminodiphenylmethane, 3,3′-dichloro-4,5′-diaminodiphenylmethane, 3,3′-dichloro-6,5′-diaminodiphenylmethane, 3,3′-dichloro-4,2′-diaminodiphenylmethane, 3,3′-dichloro-4,6′-diaminodiphenylmethane, 4,4′-dichloro-2,2′-diaminodiphenylmethane, 4,4′-dichloro-3,3′-diaminodiphenylmethane, 4,4′-dichloro-5,5′-diaminodiphenylmethane, 4,4′-dichloro-6,6′-diaminodiphenylmethane, 4,4′-dichloro-2,3′-diaminodiphenylmethane, 4,4′-dichloro-2,5′-diaminodiphenylmethane, 4,4′-dichloro-2,6′-diaminodiphenylmethane, 4,4′-dichloro-3,5′-diaminodiphenylmethane, 4,4′-dichloro-3,6′-diaminodiphenylmethane, 4,4′-dichloro-5,6′-diaminodiphenylmethane, 5,5′-dichloro-2,2′-diaminodiphenylmethane, 5,5′-dichloro-3,3′-diaminodiphenylmethane, 5,5′-dichloro-4,4′-diaminodiphenylmethane, 5,5′-dichloro-6,6′-diaminodiphenylmethane, 5,5′-dichloro-2,3′-diaminodiphenylmethane, 5,5′-dichloro-2,4′-diaminodiphenylmethane, 5,5′-dichloro-2,6′-diaminodiphenylmethane, 5,5′-dichloro-3,4′-diaminodiphenylmethane, 5,5′-dichloro-3,6′-diaminodiphenylmethane, 5,5′-dichloro-4,6′-diaminodiphenylmethane, 6,6′-dichloro-2,2′-diaminodiphenylmethane, 6,6′-dichloro-3,3′-diaminodiphenylmethane, 6,6′-dichloro-4,4′-diaminodiphenylmethane, 6,6′-dichloro-5,5′-diaminodiphenylmethane, 6,6′-dichloro-2,3′-diaminodiphenylmethane, 6,6′-dichloro-2,4′-diaminodiphenylmethane, 6,6′-dichloro-2,5′-diaminodiphenylmethane, 6,6′-dichloro-3,4′-diaminodiphenylmethane, 6,6′-dichloro-3,5′-diaminodiphenylmethane, 6,6′-dichloro-4,5′-diaminodiphenylmethane, or a mixture thereof), diaminobenzene (e.g., 1,4-diaminobenzene, 1,2-diaminobenzene, 1,3-diaminobenzene, or a mixture thereof), dimethoxy-diamino biphenyl (e.g., 2,2′-dimethoxy-3,3′-diamino biphenyl, 2,2′-dimethoxy-4,4′-diamino biphenyl, 5,5′-dimethoxy-3,3′-diamino biphenyl, 2,2′-dimethoxy-6,6′-diamino biphenyl, 2,2′-dimethoxy-3,4′-diamino biphenyl, 2,2′-dimethoxy-3,5′-diamino biphenyl, 2,2′-dimethoxy-3,6′-diamino biphenyl, 2,2′-dimethoxy-4,5′-diamino biphenyl, 2,2′-dimethoxy-4,6′-diamino biphenyl, 2,2′-dimethoxy-5,6′-diamino biphenyl, 3,3′-dimethoxy-2,2′-diamino biphenyl, 3,3′-dimethoxy-4,4-diamino biphenyl, 3,3′-dimethoxy-5,5′-diamino biphenyl, 3,3′-dimethoxy-6,6′-diamino biphenyl, 3,3′-dimethoxy-2,5′-diamino biphenyl, 3,3′-dimethoxy-4,5′-diamino biphenyl, 3,3′-dimethoxy-6,5′-diamino biphenyl, 3,3′-dimethoxy-4,2′-diamino biphenyl, 3,3′-dimethoxy-4,6′-diamino biphenyl, 4,4′-dimethoxy-2,2′-diamino biphenyl, 4,4′-dimethoxy-3,3′-diamino biphenyl, 4,4′-dimethoxy-5,5′-diamino biphenyl, 4,4′-dimethoxy-6,6′-diamino biphenyl, 4,4′-dimethoxy-2,3′-diamino biphenyl, 4,4′-dimethoxy-2,5′-diamino biphenyl, 4,4′-dimethoxy-2,6′-diamino biphenyl, 4,4′-dimethoxy-3,5′-diamino biphenyl, 4,4′-dimethoxy-3,6′-diamino biphenyl, 4,4′-dimethoxy-5,6′-diamino biphenyl, 5,5′-dimethoxy-2,2′-diamino biphenyl, 5,5′-dimethoxy-3,3′-diamino biphenyl, 5,5′-dimethoxy-4,4′-diamino biphenyl, 5,5′-dimethoxy-6,6′-diamino biphenyl, 5,5′-dimethoxy-2,3′-diamino biphenyl, 5,5′-dimethoxy-2,4′-diamino biphenyl, 5,5′-dimethoxy-2,6′-diamino biphenyl, 5,5′-dimethoxy-3,4′-diamino biphenyl, 5,5′-dimethoxy-3,6′-diamino biphenyl, 5,5′-dimethoxy-4,6′-diamino biphenyl, 6,6′-dimethoxy-2,2′-diamino biphenyl, 6,6′-dimethoxy-3,3′-diamino biphenyl, 6,6′-dimethoxy-4,4′-diamino biphenyl, 6,6′-dimethoxy-5,5′-diamino biphenyl, 6,6′-dimethoxy-2,3′-diamino biphenyl, 6,6′-dimethoxy-2,4′-diamino biphenyl, 6,6′-dimethoxy-2,5′-diamino biphenyl, 6,6′-dimethoxy-3,4′-diamino biphenyl, 6,6′-dimethoxy-3,5′-diamino biphenyl, 6,6′-dimethoxy-4,5′-diamino biphenyl, or a mixture thereof), dimethyl-diamino biphenyl (e.g., 2,2′-dimethyl-3,3′-diamino biphenyl, 2,2′-dimethyl-4,4′-diamino biphenyl, 5,5′-dimethyl-3,3′-diamino biphenyl, 2,2′-dimethyl-6,6′-diamino biphenyl, 2,2′-dimethyl-3,4′-diamino biphenyl, 2,2′-dimethyl-3,5′-diamino biphenyl, 2,2′-dimethyl-3,6′-diamino biphenyl, 2,2′-dimethyl-4,5′-diamino biphenyl, 2,2′-dimethyl-4,6′-diamino biphenyl, 2,2′-dimethyl-5,6′-diamino biphenyl, 3,3′-dimethyl-2,2′-diamino biphenyl, 3,3′-dimethyl-4,4-diamino biphenyl, 3,3′-dimethyl-5,5′-diamino biphenyl, 3,3′-dimethyl-6,6′-diamino biphenyl, 3,3′-dimethyl-2,5′-diamino biphenyl, 3,3′-dimethyl-4,5′-diamino biphenyl, 3,3′-dimethyl-6,5′-diamino biphenyl, 3,3′-dimethyl-4,2′-diamino biphenyl, 3,3′-dimethyl-4,6′-diamino biphenyl, 4,4′-dimethyl-2,2′-diamino biphenyl, 4,4′-dimethyl-3,3′-diamino biphenyl, 4,4′-dimethyl-5,5′-diamino biphenyl, 4,4′-dimethyl-6,6′-diamino biphenyl, 4,4′-dimethyl-2,3′-diamino biphenyl, 4,4′-dimethyl-2,5′-diamino biphenyl, 4,4′-dimethyl-2,6′-diamino biphenyl, 4,4′-dimethyl-3,5′-diamino biphenyl, 4,4′-dimethyl-3,6′-diamino biphenyl, 4,4′-dimethyl-5,6′-diamino biphenyl, 5,5′-dimethyl-2,2′-diamino biphenyl, 5,5′-dimethyl-3,3′-diamino biphenyl, 5,5′-dimethyl-4,4′-diamino biphenyl, 5,5′-dimethyl-6,6′-diamino biphenyl, 5,5′-dimethyl-2,3′-diamino biphenyl, 5,5′-dimethyl-2,4′-diamino biphenyl, 5,5′-dimethyl-2,6′-diamino biphenyl, 5,5′-dimethyl-3,4′-diamino biphenyl, 5,5′-dimethyl-3,6′-diamino biphenyl, 5,5′-dimethyl-4,6′-diamino biphenyl, 6,6′-dimethyl-2,2′-diamino biphenyl, 6,6′-dimethyl-3,3′-diamino biphenyl, 6,6′-dimethyl-4,4′-diamino biphenyl, 6,6′-dimethyl-5,5′-diamino biphenyl, 6,6′-dimethyl-2,3′-diamino biphenyl, 6,6′-dimethyl-2,4′-diamino biphenyl, 6,6′-dimethyl-2,5′-diamino biphenyl, 6,6′-dimethyl-3,4′-diamino biphenyl, 6,6′-dimethyl-3,5′-diamino biphenyl, 6,6′-dimethyl-4,5′-diamino biphenyl, or a mixture thereof), diamino biphenyl (e.g., 2,2′-diamino biphenyl, 2,3′-diamino biphenyl, 2,4′-diamino biphenyl, 2,5′-diamino biphenyl, 2,6′-diamino biphenyl, 3,4′-diamino biphenyl, 3,5′-diamino biphenyl, 3,6′-diamino biphenyl, 4,4′-diamino biphenyl, 4,5′-diamino biphenyl, 4,6′-diamino biphenyl, 5,6′-diamino biphenyl, or a mixture thereof), dichloro-diamino biphenyl (e.g., 2,2′-dichloro-3,3′-diamino biphenyl, 2,2′-dichloro-4,4′-diamino biphenyl, 5,5′-dichloro-3,3′-diamino biphenyl, 2,2′-dichloro-6,6′-diamino biphenyl, 2,2′-dichloro-3,4′-diamino biphenyl, 2,2′-dichloro-3,5′-diamino biphenyl, 2,2′-dichloro-3,6′-diamino biphenyl, 2,2′-dichloro-4,5′-diamino biphenyl, 2,2′-dichloro-4,6′-diamino biphenyl, 2,2′-dichloro-5,6′-diamino biphenyl, 3,3′-dichloro-2,2′-diamino biphenyl, 3,3′-dichloro-4,4′-diamino biphenyl, 3,3′-dichloro-5,5′-diamino biphenyl, 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl,4,4′-dichloro-2,2′-diamino biphenyl, 4,4′-dichloro-3,3′-diamino biphenyl, 4,4′-dichloro-5,5′-diamino biphenyl, 4,4′-dichloro-6,6′-diamino biphenyl, 4,4′-dichloro-2,3′-diamino biphenyl, 4,4′-dichloro-2,5′-diamino biphenyl, 4,4′-dichloro-2,6′-diamino biphenyl, 4,4′-dichloro-3,5′-diamino biphenyl, 4,4′-dichloro-3,6′-diamino biphenyl, 4,4′-dichloro-5,6′-diamino biphenyl, 5,5′-dichloro-2,2′-diamino biphenyl, 5,5′-dichloro-3,3′-diamino biphenyl, 5,5′-dichloro-4,4′-diamino biphenyl, 5,5′-dichloro-6,6′-diamino biphenyl, 5,5′-dichloro-2,3′-diamino biphenyl, 5,5′-dichloro-2,4′-diamino biphenyl, 5,5′-dichloro-2,6′-diamino biphenyl, 5,5′-dichloro-3,4′-diamino biphenyl, 5,5′-dichloro-3,6′-diamino biphenyl, 5,5′-dichloro-4,6′-diamino biphenyl, 6,6′-dichloro-2,2′-diamino biphenyl, 6,6′-dichloro-3,3′-diamino biphenyl, 6,6′-dichloro-4,4′-diamino biphenyl, 6,6′-dichloro-5,5′-diamino biphenyl, 6,6′-dichloro-2,3′-diamino biphenyl, 6,6′-dichloro-2,4′-diamino biphenyl, 6,6′-dichloro-2,5′-diamino biphenyl, 6,6′-dichloro-3,4′-diamino biphenyl, 6,6′-dichloro-3,5′-diamino biphenyl, 6,6′-dichloro-4,5′-diamino biphenyl, or a mixture thereof), or a mixture thereof.

In any aspect or embodiment described herein, the one or more diamine chain extender comprises, consists essentially of, or is at least one of 4,4′-diaminodiphenylmethane, 3,3′-dichloro-4,4′-diaminodiphenylmethane, 1,4-diaminobenzene, 3,3′-dimethoxy-4,4-diamino biphenyl, 3,3′-dimethyl-4,4-diamino biphenyl, 4,4′-diamino biphenyl, 3,3′-dichloro-4,4′-diamino biphenyl, or a mixtures thereof.

In any aspect or embodiment described herein, the polymeric composition is a thermoplastic polyurethane, a thermoplastic polyurethane elastomer, a hot cast polyurethane elastomer, a cold cast elastomer, a slabstock polyurethane foam, a moulded polyurethane foam, a microcellular polyurethane foam, a polyurethane dispersion in aqueous or organic media, a polyurethane adhesive, a one-component polyurethane coating, a two-component polyurethane coating, an additive manufacturing composition/resin, or a polyurethane sealant.

In any aspect or embodiment described herein, the polymeric composition is prepared by a process comprising, consisting essentially of, or consists of, reacting the one or more polycaprolactone composition (e.g., polycaprolactone polyol composition) or polycaprolactone (e.g., polycaprolactone polyol) of the present disclosure, the one or more diisocyanate, and optionally, the one or more chain extender.

In any aspect or embodiment described herein, reacting the one or more polycaprolactone composition (e.g., polycaprolactone polyol composition) or polycaprolactone (e.g., polycaprolactone polyol) of the present disclosure, the one or more diisocyanate, optionally one or more additional polyol (e.g., an additional polyol other than the polycaprolactone composition of the present disclosure or the polycaprolactone of the present disclosure), and optionally the one or more chain extender is performed in the presence of a catalyst.

In any aspect or embodiment described herein, the catalyst comprises, consists essentially of, or consists of, one or more (e.g., 1, 2, 3, 4, 5, or more) urethane catalyst (e.g., one or more (e.g., 1, 2, 3, 4, 5, or more) tertiary amine catalyst, one or more (e.g., 1, 2, 3, 4, 5, or more) amine with isocyanate reactive group(s), one or more (e.g., 1, 2, 3, 4, 5, or more) organometallic catalyst, one or more (e.g., 1, 2, 3, 4, 5, or more) organobismuth catalyst (e.g., organobismuth in a carboxylic acid), one or more (e.g., 1, 2, 3, 4, 5, or more) tin catalyst, one or more (e.g., 1, 2, 3, 4, 5 or more) catalyst for the trimerization of polyisocyanates, or a combination thereof).

In any aspect or embodiment described herein, the catalyst comprises, consists essentially of, or consists of, the catalyst comprises, consists essentially of, or consists of, at least one of (i) one or more (e.g., 1, 2, 3, 4, 5, or more) tertiary amine catalyst (e.g., a tertiary amine catalyst that is present in an amount of about 0.02 wt % to about 5 wt % of the reaction mixture) comprising, consists essentially of, or consists of, at least one of triethylenediamine, N-methylmorpholine, N, N-dimethylcyclohexylamine, pentamethyldiethylenetriamine, tetramethylethylenediamine, bis(dimethylaminoethyl) ether, 1-methyl-4-dimethylaminoethyl-piperazine, 3-methoxy-N-dimethylpropylamine, N-ethylmorpholine; dimethylethanolamine, N-cocomorpholine, N, N-dimethyl-N′, N′-dimethyl isopropylpropylenediamine, N, N-diethyl-3-diethyl amino-propylamine, dimethylbenzylamine, or a mixture thereof; (ii) one or more (e.g., 1, 2, 3, 4, 5, or more) organometallic catalyst (e.g., a organometallic catalyst that is present in an amount of about 0.001 to 1 wt % of the reaction mixture) comprising, consists essentially of, or consists of, at least one of organobismuth, organo mercury, organolead, organoferric, organotin catalysts, or a combination thereof (preferably organotin catalysts); (iii) one or more (e.g., 1, 2, 3, 4, 5, or more) tin catalysts comprising, consists essentially of, or consists of, at least one of stannous chloride, tin salts of carboxylic acids (e.g., dibutyltin dilaurate), stannous octoate, or a combination thereof; (iv) one or more (e.g., 1, 2, 3, 4, 5, or more) catalyst for the trimerization of polyisocyanates comprising, consists essentially of, or consists of, an alkali metal alkoxide; or (v) a combination thereof.

In any aspect or embodiment described herein, the one or more additional polyol is a polyol other than the polycaprolactone composition of the present disclosure or the polycaprolactone of the present disclosure.

In any aspect or embodiment described herein, the polymeric composition is prepared by a process comprising, consisting essentially of, or consists of, reacting the one or more polycaprolactone composition (e.g., polycaprolactone polyol composition) or polycaprolactone (e.g., polycaprolactone polyol) of the present disclosure, the one or more diisocyanate, one or more additional polyol, and optionally, the one or more chain extender. In any aspect or embodiment described herein, the one or more additional polyol comprises, consists essentially of, or consists of, at least one of one or more (e.g., 1, 2, 3, 4, 5, or more) dihydric alcohol (e.g., low-molecular-weight diol); one or more (e.g., 1, 2, 3, 4, 5, or more) trihydric alcohol (e.g., low-molecular-weight triol); one or more (e.g., 1, 2, 3, 4, 5, or more) tetrahydric alcohol (e.g., low-molecular-weight tetrol); one or more (e.g., 1, 2, 3, 4, 5, or more) pentahydric alcohol (e.g., low-molecular-weight pentol); one or more (e.g., 1, 2, 3, 4, 5, or more) hexahydric alcohol (e.g., a low-molecular-weight hexol); one or more (e.g., 1, 2, 3, 4, 5, or more) heptahydric alcohol (e.g., low-molecular-weight heptol); one or more (e.g., 1, 2, 3, 4, 5, or more) octahydric alcohol (e.g., low-molecular-weight octahydric alcohol); one or more (e.g., 1, 2, 3, 4, 5, or more) polyalkylene oxide having three or more hydroxyl groups (e.g., low-molecular weight polyalkylene oxide having three or more hydroxyl groups), or a combination thereof); or a combination thereof.

### EXAMPLES

### Exemplary Polycaprolactone Polyols

Exemplary polycaprolactone polyols were produced by subjecting F-caprolactone monomers (Ingevity, UK; Warrington, Cheshire, United Kingdom) to reaction (ring-opening polymerization) with initiator 1,4-cyclohexanedimethanol (Merck Sharp & Dohme; Rahway, New Jersey, United States of America) at molar ratios, yielding Exemplary Polycaprolactone Polyol 1 (Ex. 1) and Exemplary Polycaprolactone Polyol 2 (Ex. 2) according to Table 1.

TABLE 1
Exemplary Polyol Formulations and Characteristics

| Exemplary Polyol Formulations | Ex. 1 | Ex. 2 |
|---|---|---|
| Molecular Weight of Polyol (g mol⁻¹) | 1000 | 1500 |
| Initiator Content (wt %) | 14.4 | 9.6 |
| Caprolactone Content (wt %) | 85.6 | 90.4 |
| Hydroxyl Value (mgKOH/g) | 112.2 | 74.8 |
| Viscosity at 60° C. (mPa · s) | 167 | 273 |
| Acid Value (mgKOH/g) | 0.12 | 0.11 |
| Colour (Hazen) | 10 | 10 |
| Water Content (%) | <0.02 | <0.02 |

An exemplary polycaprolactone polyol was produced by subjecting ε-caprolactone (Ingevity, UK; Warrington, Cheshire, United Kingdom) to reaction (ring-opening polymerization) with initiator tricyclodecanedimethanol (OQ Chemicals; Monheim am Rhein Germany) at molar ratios yielding, Exemplary Polycaprolactone Polyol 3 (Ex. 3) according to Table 2.

TABLE 2
Exemplary Polyol Formulation and Characteristics

| Exemplary Polyol Formulations | Ex. 3 |
|---|---|
| Molecular weight of polyol (g mol⁻¹) | 1500 |
| Initiator content (wt %) | 13.1 |
| Caprolactone content (wt %) | 86.9 |
| Hydroxyl Value (mgKOH/g) | 73.6 |
| Viscosity at 60° C. (mPa · s) | 354 |
| Acid Value (mgKOH/g) | 0.07 |
| Colour (Hazen) | <10 |
| Water Content (%) | <0.013 |

Exemplary polycaprolactone polyols were produced by subjecting ε-caprolactone (Ingevity, UK) to reaction (ring-opening polymerization) with the pentaspiroglycol (Perstorp AB) at molar ratios, yielding Exemplary Polycaprolactone Polyol 4 (Ex. 4) and Exemplary Polycaprolactone Polyol 5 (Ex. 5) according to Table 3.

TABLE 3
Exemplary Polyol Formulations and Characteristics

| Exemplary Polyol Formulations | Ex. 4 | Ex. 5 |
|---|---|---|
| Molecular weight of polyol (g mol⁻¹) | 1000 | 2000 |
| Initiator content (wt %) | 30.4 | 15.2 |
| Caprolactone content (wt %) | 69.6 | 84.8 |
| Hydroxyl Value (mgKOH/g) | 108.6 | 55..2 |
| Viscosity at 60° C. (mPa · s) | 592 | 775 |
| Acid Value (mgKOH/g) | 0.03 | 0.04 |
| Colour (Hazen) | 40 | 10 |
| Water Content (%) | 0.0059 | 0.0027 |

The reactions were performed at 180° C. in the presence a metal containing catalyst and residual ε-caprolactone monitored by gas chromatography (GC). The reactions were terminated when the amount of residual ε-caprolactone was less than 0.5 wt %.

Two polyester type initiators were produced via condensation reaction. The first variation was produced using 1,4-cyclohexanedimethanol and glutaric acid (Merck Sharp & Dohme; Rahway, New Jersey, United States of America), 3 parts to 2 parts, to produce an exemplary polycaprolactone polyol via the ring opening of ε-caprolactone (Ingevity, UK) at molar ratios, yielding Exemplary Polycaprolactone Polyol 6 (Ex. 6) in Table 4. A second variation used 1,4-cyclohexanedimethanol and 1,4-cyclohexanediacid (Merck Sharp & Dohme; Rahway, New Jersey, United States of America), 3 parts to 2 parts, to produce a an exemplary polycaprolactone polyol via the ring opening of ε-caprolactone (Ingevity, UK) at molar ratios, yielding Exemplary Polycaprolactone Polyol 7 (Ex. 7) in Table 4.

TABLE 4
Exemplary Polyol Formulations and Characteristics

| Exemplary Polyol Formulations | Ex. 6 | Ex. 7 |
|---|---|---|
| Molecular weight of polyol (g mol⁻¹) | 2000 | 2000 |
| Initiator content (wt %) | 30.9 | 37.4 |
| Caprolactone content (wt %) | 69.1 | 62.6 |
| Hydroxyl Value (mgKOH/g) | 52 | 56.7 |
| Viscosity at 60° C. (mPa · s) | 1026 | 1848 |
| Acid Value (mgKOH/g) | 0.02 | 0.12 |
| Colour (Hazen) | 10 | 40 |
| Water Content (%) | 0.013 | 0.014 |

CAPA® 2101A (Comparative Polyol 1; Ingevity, UK, Warrington, Cheshire, United Kingdom), and CAPA® 2125 (Comparative Polyol 2; Ingevity, UK, Warrington, Cheshire, United Kingdom) were utilized comparative materials as they are polyols that are typically used in high performing polyurethane applications.

### Thermoplastic Polyurethane Elastomers

Examples of the compositions and methods described and comparative examples were prepared via a one-shot bulk polymerization process (TPE 1-TPE 12).

A one-shot bulk polymerisation was performed to prepare thermoplastic polyurethane elastomer materials according to Table 5. The requisite polyol was directly added to hydrogenated methylenediphenyl diisocyanate (Fisher Chemicals; Waltham, Massachusetts), 1,4-butanediol (Orange Chemicals FZ LLC; Ras Al Khaimah, United Arab Emirates) and FORMEZ® UL-28 catalyst (Momentive; Niskayuna, New York), according to 100% isocyanate index. The mixture was homogenised using a vortex mixer for 30 seconds, then degassed under vacuum for 2 minutes before casting on to a metal plate at 90° C. This was transferred to a curing oven at 90° C. for 16 hours before being demoulded and cooled to 23° C.

TABLE 5
Thermoplastic Polyurethane Elastomer (TPE) Formulations

| Ex. | | Parts | Parts | Parts Chain | Parts |
|---|---|---|---|---|---|
| No. | Polyol | Polyol | Isocyanate | Extender | Catalyst |
| TPE 1 | Ex. 1 | 50 | 41 | 9 | 0.0018 |
| TPE 2 | Ex. 2 | 50 | 39.5 | 10.5 | 0.0021 |
| TPE 3 | Ex. 2 | 55 | 36 | 9 | 0.0018 |
| TPE 4 | Ex. 3 | 55 | 36 | 9 | 0.0018 |
| TPE 5 | Ex. 4 | 62.5 | 32 | 5.5 | 0.0011 |
| TPE 6 | Ex. 5 | 55 | 35 | 10 | 0.0020 |
| TPE 7 | Ex. 6 | 50 | 39 | 11 | 0.0022 |
| TPE 8 | Ex. 6 | 57.5 | 33.5 | 9 | 0.0018 |
| TPE 9 | Ex. 7 | 50 | 39 | 11 | 0.0022 |
| TPE 10 | Ex. 7 | 60 | 32 | 8 | 0.0016 |
| TPE 11 | Comparative | 50 | 41 | 9 | 0.0018 |
| | Polyol 1 | | | | |
| TPE 12 | Comparative | 50 | 41 | 9 | 0.0018 |
| | Polyol 2 | | | | |

The hardness properties of the polyurethane material were determined according to International Organization for Standardization (ISO) standard 48-4:2018—Rubber, vulcanized or thermoplastic—Determination of hardness—Part 4: Indentation hardness by durometer method (Shore hardness). Briefly, hardness was examined according to ISO 44:2018 using a digital benchtop shore A durometer with a 3 second hold; and a handheld analogue shore D durometer with a 0 second hold time. Test pieces were cut from sheets of 2.0 mm+/−0.2 mm in thickness, stacked 3 times on top of one another.

The mechanical properties of the polyurethane material were determined according to International Organization for Standardization (ISO) standard 37:2024—Rubber, vulcanized or thermoplastic—Determination of tensile stress-strain properties, and American Society for Testing and Materials (ASTM) D 624-00 (2020)—Standard Test Method for Tear Strength of Conventional Vulcanized Rubber and Thermoplastic Elastomers.

Tensile tests were conducted according to ISO 37:2024 using Type 2 specimens (dumbbell-shaped test pieces of 2.0 mm+/−0.2 mm in thickness and a test length of 20 mm+/−0.5 mm). Test pieces were cut from 2.0 mm polyurethane sheets using a die-cutter and then conditioned at 23° C./50% relative humidity for a period of 7 days prior to testing. Test pieces were subjected to deformation in tensile mode at a rate of traverse of 200 mm/minute using a ZwickRoell Proline Z010 tensometer equipped with pincer grips and a 10 kN load cell until the test piece is broken. Ultimate tensile strength is defined as the stress recorded at breakage of the sample, in megapascals (MPa or N/mm2). Ultimate elongation is defined as the percentage increase in test length at break. The elastic modulus is defined as the average stress/strain between 0.25% and 0.5% elongation of the material and is a measure of the material's resistance to deformation.

Tear strength tests were conducted according to ASTM D624-00 (2020) using Die C/right angle specimens (an un-nicked test piece with a 900 right angle on one side and with tab ends) of 2.0 mm+/−0.2 mm thickness. Test pieces were cut from 2.0 mm polyurethane sheets using a die-cutter and then conditioned at 23° C./50% relative humidity for a period of 7 days prior to testing. Test pieces were subjected to deformation in tensile mode at a rate of traverse of 500 mm/min using a Proline Z010 tensometer (ZwickRoell Group; Ulm, Germany) equipped with pincer grips and a 10 kN load cell until the test piece is completely torn. Tear strength is defined as the force required to cause a rupture of the test piece, divided by the thickness of the test piece.

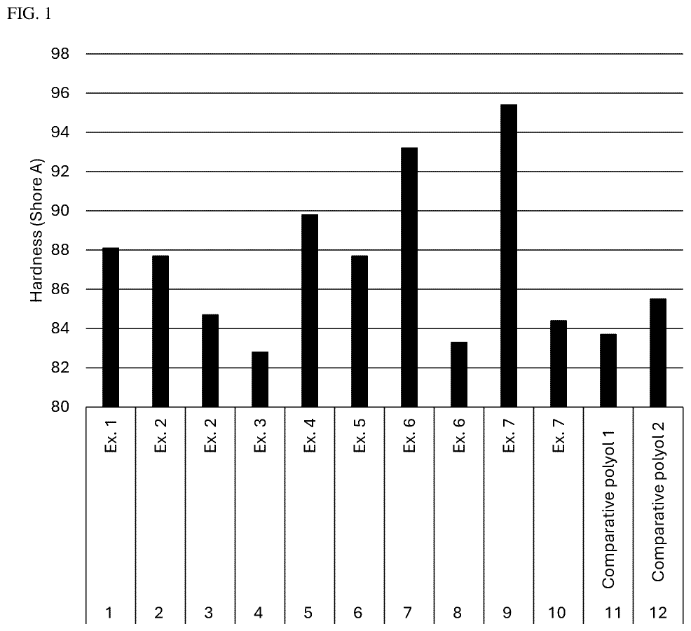

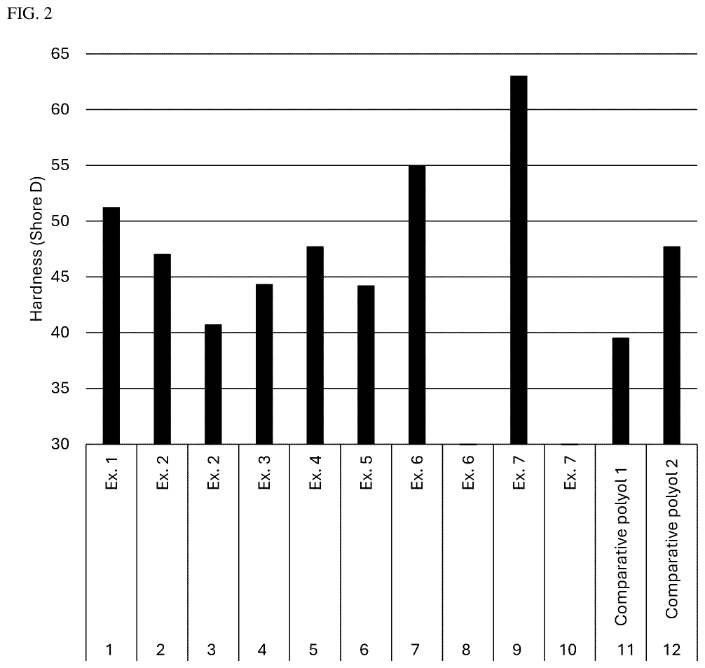

The characteristics of Thermoplastic Polyurethane Elastomer 1 (TPE 1) through Thermoplastic Polyurethane Elastomer 12 (TPE 12) are shown in Table 6, Table 7, FIG. 1, and FIG. 2. A significant improvement in hardness was observed with TPE 1, TPE 2, TPE 6, TPE 7, and TPE 9 prepared with Exemplary Polycaprolactone Polyol 1 (Ex. 1), Exemplary Polycaprolactone Polyol 2 (Ex. 2), Exemplary Polycaprolactone Polyol 5 (Ex. 5), Exemplary Polycaprolactone Polyol (Ex. 6), and Exemplary Polycaprolactone Polyol 7 (Ex. 7) as compared to an equivalent formulation based on comparative polyols (TPE 11 and TPE 12). An equivalent or higher performance in hardness and tensile strength was observed when comparing to a formulation based on a greater percentage of comparative polyol (TPE 3, TPE 4, TPT 8, and TPP 10). FIGS. 1 and 2 illustrate the difference in hardness of thermoplastic polyurethane elastomers prepared with exemplary polycaprolactone compositions of the present disclosure (Ex. 1 through Ex. 7) as compared to commercially available comparative materials. FIG. 1 shows the Shore A values for TPE 1 through TPE 12, left to right, and FIG. 2 shows the Shore D values for TPE 1 through TPE 12, left to right.

TABLE 6
Characteristic of Thermoplastic Polyurethane Elastomers

| | TPE 1 | TPE 2 | TPE 3 | TPE 4 | TPE 5 | TPE 6 |
|---|---|---|---|---|---|---|
| Exemplary Polyol | Ex. 1 | Ex. 2 | Ex. 2 | Ex. 3 | Ex. 4 | Ex. 5 |
| Hardness (Shore A) | 88.1 | 87.7 | 84.7 | 82.8 | 89.8 | 87.7 |
| Hardness (Shore D) | 51.2 | 47 | 40.7 | 44.3 | 47.7 | 44.2 |
| Tensile strength @ | 12.1 | 12.3 | 8 | 9.7 | 5.6 | 9.2 |
| 100% (MPa) | | | | | | |
| Ultimate Tensile | 53.8 | 42.5 | 45.7 | 22.3 | 24.4 | 36 |
| Strength (MPa) | | | | | | |
| Ultimate Elongation (%) | 292 | 324 | 348 | 392 | 320 | 376 |
| Tear Strength (kN/m) | 85 | 95.8 | 78.3 | 90.4 | 54.4 | 88.1 |
| Modulus of Elasticity (MPa) | 92.5 | 80.4 | 38.6 | 59.3 | 92.9 | 62.5 |
| Tg (DSC cycle 1) (° C.) | 4.7 | −19.9 | −26.1 | −21 | 10.4 | −20.5 |
| Tg (DSC cycle 2) (° C.) | 13 | 2.5 | −13 | −1.7 | 15.9 | −2.8 |

TABLE 7
Characteristic of Thermoplastic Polyurethane Elastomers

| | TPE 7 | TPE 8 | TPE 9 | TPE 10 | TPE 11 | TPE 12 |
|---|---|---|---|---|---|---|
| Exemplary Polyol | Ex. 6 | Ex.6 | Ex. 7 | Ex. 7 | Comparative | Comparative |
| | | | | | Polyol 1 | Polyol 2 |
| Hardness (Shore A) | 93.2 | 83.3 | 95.4 | 84.4 | 83.7 | 85.5 |
| Hardness (Shore D) | 54.9 | NM | 63.0 | NM | 39.5 | 47.7 |
| Tensile strength @ | 10 | 6.6 | 12.6 | 3.9 | 10 | 10.6 |
| 100% (MPa) | | | | | | |
| Ultimate Tensile | 23.4 | 16.9 | 27.1 | 20.9 | 36.1 | 33.5 |
| Strength (MPa) | | | | | | |
| Ultimate Elongation (%) | 347 | 438 | 322 | 426 | 298 | 318 |
| Tear Strength (kN/m) | 98.1 | 76.2 | 123.6 | 58.9 | 91.9 | 85.9 |
| Modulus of Elasticity (MPa) | 134 | 43.1 | 263.6 | 39.2 | 68.9 | 62.1 |
| Tg (DSC cycle 1) (° C.) | −16.7 | −24.7 | 16.2 | −3.7 | −6.3 | −21.4 |
| Tg (DSC cycle 2) (° C.) | 10 | −5.6 | 22.3 | 6.4 | 6.5 | −5.7 |

NM = not measured

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the disclosure may be utilized in numerous combinations, all of which are expressly contemplated by the present description. These additional aspects and embodiments are expressly included within the scope of the present disclosure. The publications and other materials used herein to illuminate the background of the disclosure, and in particular cases, to provide additional details respecting the practice, are incorporated by reference.

Thus, those skilled in the art will recognize, or be able to ascertain using no more than routine experimentation, many equivalents to the specific embodiments of the disclosure described herein. Such equivalents are intended to be encompassed by the following claims. It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. A polycaprolactone composition comprising a polycaprolactone comprising a reaction product of (i) one or more cyclic aliphatic initiator and (ii) one or more unsubstituted or substitute caprolactone monomer, wherein
the one or more cyclic aliphatic initiator is present in the range of about 1.0 wt % to about 95.0 wt % of the total molecular weight of the polycaprolactone composition,
the one or more caprolactone monomer is present in the range of about 5.0 wt % to about 99.0 wt % of the total molecular weight of the polycaprolactone composition, and
the polycaprolactone has an average molecular weight of about 400 g/mol to about 10,000 g/mol.

2. The polycaprolactone composition of claim 1, wherein the reaction product is produced by a process comprising at least one of:
reacting the one or more cyclic aliphatic initiator and the one or more caprolactone monomer;
reacting the one or more cyclic aliphatic initiator and the one or more caprolactone monomer at a temperature of about 120° C. to about 200° C.;
reacting the one or more cyclic aliphatic initiator and the one or more caprolactone monomer for about 0.25 hours to about 100.0 hours;
reacting the one or more cyclic aliphatic initiator and the one or more caprolactone monomer in a standard atmosphere or an inert atmosphere;
reacting the one or more cyclic aliphatic initiator and the one or more caprolactone monomer at a pressure of less than about 1,000 millibar (mbar);
reacting the one or more cyclic aliphatic initiator and the one or more caprolactone monomer in the presence of a catalyst; or
a combination thereof.

3. A polycaprolactone composition comprising a polycaprolactone comprising a reaction product of (i) one or more cyclic aliphatic initiator, (ii) one or more aliphatic dicarboxylic acid, and (iii) one or more unsubstituted or substitute caprolactone monomer, wherein:
the one or more cyclic aliphatic initiator and the one or more aliphatic dicarboxylic acid are present in the range of about 1.0 wt % to about 95.0 wt % of the total molecular weight of the polycaprolactone composition,
the one or more caprolactone monomer is present in the range of about 5.0 wt % to about 99.0 wt % of the total molecular weight of the polycaprolactone composition, and
the polycaprolactone has an average molecular weight of about 400 g/mol to about 10,000 g/mol.

4. The polycaprolactone composition of claim 3, wherein at least one of:
the one or more aliphatic dicarboxylic acid comprises, consists essentially of, or consists of, at least one of one or more cyclic aliphatic dicarboxylic acid, one or more linear aliphatic dicarboxylic acid, or a combination thereof;
a ratio of the one or more cyclic aliphatic initiator to the one or more aliphatic dicarboxylic acid is about 3:1 to about 2:3; or
a combination thereof.

5. The polycaprolactone composition of claim 3, wherein the reaction product is produced by a process comprising, consisting essentially of, or consisting of, at least one of:
reacting the one or more cyclic aliphatic initiator, the one or more aliphatic dicarboxylic acid, and the one or more caprolactone monomer;
reacting the one or more cyclic aliphatic initiator, the one or more aliphatic dicarboxylic acid, and the one or more caprolactone monomer at a temperature of about 120° C. to about 200° C.;
reacting the one or more cyclic aliphatic initiator, the one or more aliphatic dicarboxylic acid, and the one or more caprolactone monomer for about 0.25 hours to about 100.0 hours;
reacting the one or more cyclic aliphatic initiator, the one or more aliphatic dicarboxylic acid, and the one or more caprolactone monomer in a standard atmosphere or an inert atmosphere;
reacting the one or more cyclic aliphatic initiator, the one or more aliphatic dicarboxylic acid, and the one or more caprolactone monomer at a pressure of less than about 1,000 millibar (mbar);
reacting the one or more cyclic aliphatic initiator, the one or more aliphatic dicarboxylic acid, and the one or more caprolactone monomer in the presence of a catalyst; or
a combination thereof.

6. The polycaprolactone composition of claim 2, wherein the process further comprises, consists essentially of, or consists of, at least one of:
prior to reacting, removing water by heating the one or more cyclic aliphatic initiator, the one or more aliphatic dicarboxylic acid, the one or more caprolactone monomer, or a mixture thereof, at a temperature of about 40° C. to about 110° C.;
removing water by heating the polycaprolactone composition, the polycaprolactone, or the reaction product at a temperature of about 50° C. to about 110° C.; or
a combination thereof.

7. The polycaprolactone composition of claim 1, wherein at least one of:
(a) the one or more cyclic aliphatic initiator is a polyol;
(b) the one or more cyclic aliphatic initiator comprises:
(i) a cyclic group comprises, consists essentially of, or consists of, at least one of:
(1) a monocyclic aliphatic group,
(2) a fused cyclic ring system comprising two or more aliphatic rings,
(3) a spirocyclic ring system comprising two or more aliphatic rings,
(4) a bridged cyclic ring system comprising two or more aliphatic rings, or
(5) a combination thereof; and
(ii) two or more hydroxyl containing groups; or
(c) a combination thereof.

8. The polycaprolactone composition of claim 4, wherein at least one of:
(a) the cyclic group comprises, consists essentially of, or consists of, 5 to 20 carbon atoms;
(b) the two or more hydroxyl containing groups comprises at least one of:
(i) one or more primary hydroxyl groups,
(ii) one or more alkoxyl group, or
(iii) a combination thereof; or
(c) a combination thereof.

9. The polycaprolactone composition of claim 1, wherein at least one of:
the one or more cyclic aliphatic initiator comprises at least one cyclohexanedimethanol;
the one or more cyclic aliphatic initiator comprises at least one of pentasprioglycol, a tricyclodecane polyol, or a combination thereof; or
a combination thereof.

10. The polycaprolactone composition of claim 1, wherein the one or more caprolactone monomer comprises an unsubstituted caprolactone.

11. The polycaprolactone composition of claim 1, wherein the one or more caprolactone monomer comprises a substituted caprolactone.

12. The polycaprolactone composition of claim 1, wherein the polycaprolactone has an average molecular weight of about 500 g/mol to about 4000 g/mol or about 1000 g/mol to about 4000 g/mol.

13. A method of making or producing the polycaprolactone composition or polycaprolactone of claim 1, the method comprising, consisting essentially of, or consisting of, reacting the one or more cyclic aliphatic initiator, and the one or more caprolactone monomer.

14. A polymeric composition comprising a reaction product of:
(a) one or more polycaprolactone composition or polycaprolactone of claim 1 that is present in the range of about 5.0 wt % to about 95.0 wt % of the polymeric composition, wherein the one or more polycaprolactone composition or polycaprolactone has an average molecular weight of about 400 g/mol to about 10,000 g/mol;
(b) one or more diisocyanate that is present in the range of about 5.0 wt % to about 95.0 wt % of the polymeric composition;
(c) one or more additional polyol that is present in the range of about 0.0 wt % to about 90.0 wt % of the polymeric composition; and
(d) optionally one or more chain extender, wherein the one or more chain extender comprises at least one of, one or more diol chain extender, one or more diamine chain extender, or a combination thereof, wherein the one or more chain extender has a molecular weight of about 60.0 g/mol to about 600.0 g/mol, with an NCO:OH molar ratio of about 0.9:1 to about 2:1, and is present in a range of about 0.0 wt % to about 25.0 wt % of the polymeric composition.

15. The polymeric composition of claim 14, wherein at least one of:
the one or more diisocyanate comprises or is at least one of 4,4′-diphenylmethane diisocyanate, isophorone diisocyanate, bimethylene diisocyanate, trimethylene diisocyanate, tetramethylene diisocyanate, pentamethylene diisocyanate, hexamethylene diisocyanate, heptamethylene diisocyanate, toluene diisocyanate, naphthylene diisocyanate, cyclohexylmethane diisocyanate, dicyclohexylmethane diisocyanate, or a mixture thereof;
the one or more diisocyanate comprises at least one of 4,4′-diphenylmethanediisocyanate, isophorone diisocyanate, 1,6-hexamethylene diisocyanate, toluene-2,4-diisocyanate, 1,5-napthylene diisocyanate, 4,4′-dicyclohexylmethane diisocyanate, or a mixture thereof;
the one or more diol chain extender comprises or is an aliphatic diol or an aromatic diol; or
a combination thereof.

16. The polymeric composition of claim 15, wherein at least one of:
the one or more diol chain extender comprises at least one of an alkylene oxide or glycol, ethylene glycol, propanediol, butanediol, pentadiol, hexanediol, heptadiol, dihydroxybenzene, di(hydroxyethyl)-hydroxyquinone, di(hydroxymethyl)-hydroxyquinone, di-(hydroxyethyl)-bisphenol A, or a mixture thereof;
the one or more diamine chain extender comprises or is at least one of diaminodiphenylmethane, dichloro-diaminodiphenylmethane, diaminobenzene, dimethoxy-diamino biphenyl, diamino biphenyl, dichloro-diamino biphenyl, or a mixture thereof; or
a combination thereof.

17. The polymeric composition of claim 15, wherein at least one of:
the one or more diol chain extender comprises at least one of ethylene glycol, 1,4-butanediol, 1,6-hexanediol, 1,4-di-(betahydroxyethyl)-hydroxyquinone, 1,4-di-(betahydroxyethyl)-bisphenol A, or a mixture thereof;
the one or more diamine chain extender comprises at least one of 4,4′-diaminodiphenylmethane, 3,3′-dichloro-4,4′-diaminodiphenylmethane, 1,4-diaminobenzene, 3,3′-dimethoxy-4,4-diamino biphenyl, 3,3′-dimethyl-4,4-diamino biphenyl, 4,4′-diamino biphenyl, 3,3′-dichloro-4,4′-diamino biphenyl, or a mixtures thereof; or
a combination thereof.

18. The polymeric composition of claim 14, wherein the polymeric composition is a thermoplastic polyurethane, a thermoplastic polyurethane elastomer, a hot cast polyurethane elastomer, a cold cast elastomer, a slabstock polyurethane foam, a moulded polyurethane foam, a microcellular polyurethane foam, a polyurethane dispersion in aqueous or organic media, a polyurethane adhesive, a one-component polyurethane coating, a two-component polyurethane coating, an additive manufacturing composition/resin, or a polyurethane sealant.

19. The polymeric composition of claim 14, wherein at least one of:
the one or more polycaprolactone composition is present in the range of about 20.0 wt % to about 80.0 wt % of the polymeric composition;
the one or more diisocyanate is present in the range of about 20.0 wt % to about 80.0 wt % of the polymeric composition;
the one or more diol chain extender, the one or more diamine chain extender, or the combination thereof, is present in the range of about 0.0 wt % to about 15.0 wt % of the polymeric composition; or
a combination thereof.

20. The polymeric composition of claim 14, wherein at least one of:
the one or more polycaprolactone composition is present in the range of about 5.0 wt % to about 80.0 wt % of the polymeric composition;
the one or more additional polyol is present in the range of up to about 75.0 wt % of the polymeric composition;
the combination of the one or more polycaprolactone composition and the one or more additional polyol is present in the range of about 20.0 wt % to about 80.0 wt % of the polymeric composition;
the one or more diisocyanate is present in the range of about 20.0 wt % to about 80.0 wt % of the polymeric composition;
the one or more diol chain extender, the one or more diamine chain extender, or the combination thereof, is present in the range of about 0.0 wt % to about 15.0 wt % of the polymeric composition; or
a combination thereof.

21. The polymeric composition of claim 14, wherein the polymeric composition is prepared by a process comprising reacting the one or more polycaprolactone composition, the one or more diisocyanate, and optionally, the one or more chain extender.

22. A method of making or producing the polymeric composition of claim 14, the method comprising reacting the one or more polycaprolactone composition, the one or more diisocyanate, optionally the one or more additional polyol, and optionally the one or more chain extender.

23. A thermoplastic polyurethane, a thermoplastic polyurethane elastomer, a hot cast elastomer, a cold cast elastomer, a slabstock polyurethane foam, a moulded polyurethane foam, a microcellular polyurethane foam, a polyurethane dispersion in aqueous or organic media, a polyurethane adhesive, a one-component polyurethane coating, a two-component polyurethane coating, an additive manufacturing composition/resin, or a polyurethane sealant, comprising the one or more polycaprolactone composition or polycaprolactone of claim 1.
